(19) United States
(12) Patent Application Publication
(10) Pub. No.: US 2017/0325210 A1
(43) Pub. Date: Nov. 9, 2017

(54) LOCATION GUIDED VEHICULAR CHANNEL MANAGEMENT

(71) Applicant: QUALCOMM Incorporated, San Diego, CA (US)

(72) Inventors: Michael Richard GREEN, Needham, MA (US); Xinzhou WU, San Diego, CA (US)

(21) Appl. No.: 15/150,328

(22) Filed: May 9, 2016

(51) Int. Cl. H04W 72/04; H04L 12/28

(52) U.S. Cl. CPC H04W 72/048; H04L 12/28; H04W 72/0453

(57) ABSTRACT

A method, an apparatus, and a computer-readable medium for wireless communication are provided. In one aspect, an apparatus is configured to determine device information associated with the apparatus. The device information identifies at least one channel on which the apparatus is communicating. The at least one channel is a WLAN channel and/or a DSRC channel. The apparatus is configured to transmit a feedback report that includes the device information over a WAN connection.

### BACKGROUND

### Field

The present disclosure relates generally to communication systems, and more particularly, to location guided vehicular channel management.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), wireless wide area network (WWAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks. For example, WLANs provide connectivity within limited areas such as an office building, home, or vehicle. An increasing number of wireless devices, however, had led to greater network traffic, which has led to the need to make additional frequency bands (e.g., the 5 gigahertz band) available for different types of wireless transmission. A need exists to coordinate the use of frequency bands that are being designated for and shared by multiple wireless technologies.

### SUMMARY

The systems, methods, computer-readable medium, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus for wireless communication. The apparatus is configured to determine device information associated with the apparatus. The device information may identify at least one channel on which the apparatus is communicating, and the at least one channel may be a WLAN channel or a dedicated short range communications (DSRC) channel. The apparatus may be configured to transmit a feedback report that includes the device information over a WAN connection.

Another aspect of the disclosures provides for a computer-readable medium of a wireless device storing computer executable code for wireless communication. The computer-readable medium includes code for determining device information associated with the wireless device. The device information may identify at least one channel on which the wireless device is communicating, and the at least one channel may be a WLAN channel or a DSRC channel. The computer-readable medium may include code for transmitting a feedback report that includes the device information over a WAN connection. In another aspect, the device information may include at least one of a device identifier associated with the wireless device, a position of the wireless device, a speed at which the wireless device is moving, or a direction in which the wireless device is moving. In another aspect, the feedback report may indicate at least one of a time at which the feedback report was transmitted or a modulation type for each of the WLAN channels or the DSRC channels on which the wireless device is communicating. In another configuration, the computer-readable medium may include code for receiving additional device information associated with at least one other wireless device. In this configuration, the feedback report may include the additional device information associated with the at least one other wireless device. In another configuration, the computer-readable medium may include code for determining an amount of activity on wireless channels. The code for determining the amount of activity may include code for determining a first amount of activity on one or more WLAN channels and for determining a second amount of activity on one or more DSRC channels. In this configuration, the feedback report may indicate the amount of activity on the wireless channels. In another configuration, the computer-readable medium may include code for transmitting a request to communicate on a WLAN channel or a DSRC channel, and the request may include at least one of a position of the wireless device, a speed at which the wireless device is moving, or a direction in which the wireless device is moving. The computer-readable medium may include code for receiving channel status information based on the transmitted request, and the channel status information may indicate at least one of an allocated WLAN channel or an allocated DSRC channel. The computer-readable medium may include code for selecting a channel based on the received channel status information. In another configuration, the computer-readable medium may include code for transmitting a message indicating the selected channel on which the wireless device is communicating. In another configuration, the computer-readable medium may include code for updating device information associated with the wireless device, and the device information may include at least one of the position of the wireless device, the speed at which the wireless device is moving, or the direction in which the wireless device is moving, for transmitting the updated device information, and for receiving a channel move request based on the updated device information.

Another aspect of this disclosure provides an apparatus (e.g., a network service, a core network, or a network entity) for wireless communication. The apparatus may be configured to receive a feedback report from a first wireless device. The feedback report may indicate a channel on which the first wireless device is communicating, a position of the first wireless device, a speed at which the first wireless device is moving, and a direction in which the first wireless device is moving. The apparatus may be configured to receive, from a second wireless device, a request to communicate on a WLAN channel or a DSRC channel. The apparatus may be configured to allocate a set of channels to the second wireless device based on the received feedback report and the received request. The apparatus may be configured to transmit channel status information to the second wireless device that indicates the allocated set of channels.

Another aspect of the disclosures provides for a computer-readable medium of a wireless device storing computer executable code for wireless communication. The computer-readable medium may include code for receiving a feedback report from a first wireless device. The feedback report may indicate a channel on which the first wireless device is communicating, a position of the first wireless device, a speed at which the first wireless device is moving, and a direction in which the first wireless device is moving. The computer-readable medium may include code for receiving, from a second wireless device, a request to communicate on a WLAN channel or a DSRC channel. The computer-readable medium may include code for allocating a set of channels to the second wireless device based on the received feedback report and the received request. The computer-readable medium may include code for transmitting channel status information to the second wireless device that indicates the allocated set of channels. In an aspect, the request may include at least one of a position of the second wireless device, a speed at which the second wireless device is moving, or a direction in which the second wireless device is moving. In another aspect, the code for allocating the set of channels may further include code for determining a distance between the first wireless device and the second wireless device based on the position of the first wireless device and the position of the second wireless device and for identifying the set of channels based on the distance between the first wireless device and the second wireless device. In another configuration, the code for allocating the set of channels may include code for determining a first expected position of the first wireless device during a communication interval associated with one or more available channels based on the position, the speed, and the direction of the first wireless device, for determining a second expected position of the second wireless device during the communication interval based on the position, the speed, and the direction of the second wireless device, for determining an expected distance between the first wireless device and the second wireless device during the communication interval based on the first expected position and the second expected position, and for identifying the set of channels based on the expected distance between the first wireless device and the second wireless device. In this configuration, the set of channels may be a subset of the one or more available channels. In another configuration, the computer-readable medium may include code for receiving additional feedback reports from additional wireless devices, and the set of channels may be allocated based on the received additional feedback reports. In another configuration, the computer-readable medium may include code for the request may indicate device capabilities associated with the second wireless device, and the set of channels may be allocated based on the device capabilities indicated in the request. In another configuration, the computer-readable medium may include code for receiving updated device information from the second wireless device, for allocating a second set of channels to the second wireless device based on the updated device information, and for transmitting a channel move request to the second wireless device based on the allocated second set of channels.

### BRIEF DESCRIPTION OF THE DRAWINGS

FIG. 1 shows an example wireless communication system in which aspects of the present disclosure may be employed.

FIG. 2 is an exemplary high level flow diagram of a method of channel management for DSRC and Wi-Fi.

FIG. 3 is an exemplary detailed flow diagram of a method of channel management for DSRC and Wi-Fi.

FIG. 4 is an exemplary diagram of a wireless network employing channel management for DSRC and Wi-Fi.

FIG. 5 illustrates an exemplary channel map for a single cell in a radio access network.

FIG. 6 shows an example functional block diagram of a wireless device that may provide feedback reports and receive channel status information within the wireless communication system of FIG. 1.

FIGS. 7 and 8 are flowcharts of an example method for providing feedback for channel management and for selecting a Wi-Fi and/or DSRC channel for communication based on network channel management.

FIG. 9 is a functional block diagram of an example wireless communication device that may provide feedback reports and receive channel status information for Wi-Fi/DSRC channels.

FIG. 10 shows an example functional block diagram of a wireless device that may perform channel management within the wireless communication system of FIG. 1.

FIGS. 11-12 are flowcharts of an example method for performing Wi-Fi and DSRC channel management.

FIG. 13 is a functional block diagram of an example wireless communication device that performs channel management.

### DETAILED DESCRIPTION

Various aspects of the novel systems, apparatuses, computer-readable medium, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer-readable media, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs” Or UEs). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard and/or the LTE standard, for example. Such devices, whether used as a STA or an AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

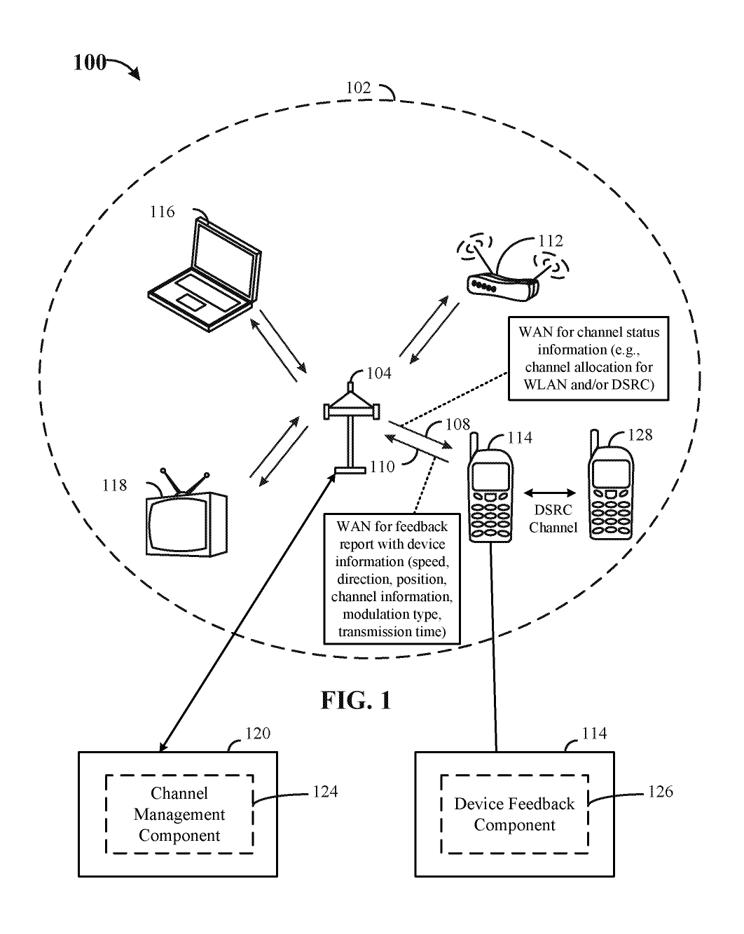

FIG. 1 shows an example wireless communication system 100 in which aspects of the present disclosure may be employed. The wireless communication system 100 may operate pursuant to one or more wireless standards, for example the 802.11 standard and/or the LTE standard. The wireless communication system 100 may include an AP 104, which communicates with STAs (e.g., STAs 112, 114, 116, 118, and 128). In the present disclosure, the term STA may be used interchangeably with the term UE (user equipment). In aspect, the AP 104 may be an access point in a WLAN or a base station (e.g., an evolved Node B) in an LTE network, for example. The wireless communication system 100 may include a core network 120. In an aspect, the core network 120 may be an Evolved Packet Core of an LTE network or a network entity.

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, either from the beacon or probe response frames, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the STA 114 may include one or more components for performing various functions. For example, the STA 114 may include a device feedback component 126 to perform procedures related to providing feedback reports and receiving channel status information. The device feedback component 126 may be configured to determine device information associated with the STA 114. The device information may identify at least one channel on which the STA 114 is communicating (e.g., over a DSRC channel with the STA 128). The at least one channel may be a WLAN channel or a DSRC channel. The device feedback component 126 may be configured to transmit a feedback report that includes the device information over a WAN connection.

In another aspect, the core network 120 may include one or more components for performing various functions. For example, the core network 120 may include a channel management component 124 to manage WLAN and/or DSRC channels. In one configuration, the channel management component 124 may be configured to receive a feedback report from a first wireless device. The feedback report may indicate a channel on which the first wireless device is communicating, a position of the first wireless device, a speed at which the first wireless device is moving, and a direction in which the first wireless device is moving. The channel management component 124 may be configured to receive, from a second wireless device, a request to communicate on a WLAN channel or a DSRC channel. The channel management component 124 may be configured to allocate a set of channels to the second wireless device based on the received feedback report and the received request. The channel management component 124 may be configured to transmit channel status information to the second wireless device that indicates the allocated set of channels.

As wireless connectivity expands, many vehicles will become equipped with on-board infotainment and hotspot capability. Vehicles may include wide area data connectivity via built-in LTE (e.g., an onboard unit may have a transceiver capable of providing cellular communications) or mobile handsets carried within the vehicles. Local connectivity within the vehicle may use Wi-Fi (e.g., 2.4 gigahertz (GHz) or 5 GHz channels) or DSRC communications.

With an increasing density of mobile basic service sets (BSSs), interference problems may arise. Overlapping BSSs may cause transient and intermittent co-channel interference when on-board access point devices move in and out of range rapidly and repeatedly. With a limited number of 5 GHz channels, for example, vehicles traveling in the same direction (especially on a highway with a high vehicle density) may experience co-channel interference when two or more vehicles come within close range while operating in the same 5 GHz channel. Co-channel interference may occur quickly (e.g., a vehicle merging onto a highway or fast moving vehicles passing slow moving vehicles). Similarly, fast or slow moving vehicles passing within close range in opposite directions may cause similar intermittent, fast onset co-channel interference.

Co-channel interference may interrupt data communications (e.g., for video streaming and other user services). This type of interference may not be adequately mitigated by prior standardization techniques in the IEEE 802.11 standard because it was not foreseen that access point devices would be deployed at high density in the same area while moving in and out of range of each other. As such, a need exists for a channel planning/management solution.

With respect to 5 GHz communications, previously, the 5 GHz band was primarily used for radar signaling such as in radio-navigation, satellite transmissions, radio-location, weather, etc. Increasingly, however, the 5 GHz band is being used by individual users for Wi-Fi and DSRC communications. By enabling mixed use of the 5 GHz channels, interference to radar transmission and reception may increase. To avoid interference with radar systems, wireless devices operating in the 5 GHz bands may need to comply with radar detection and dynamic frequency selection (DFS) conformance rules. Before transmitting on the 5 GHz bands, a DFS device (e.g., a WLAN AP, a STA, or other wireless device that transmits in the 5 GHz band) may independently detect radar by performing channel availability checks (CACs) to listen for the presence of radar signals. If radar is detected on a channel, then the DFS device may not use the channel and may flag the channel as unavailable. If radar is not detected on the channel (e.g., if a channel is free from radar for at least 60 seconds), then the DFS device may use the 5 GHz channel for communication.

Requiring each device to independently perform and repeat such channel availability checks on every 5 GHz band channel may be a waste of resources, especially when another device within proximity has already determined that one or more 5 GHz channels contains radar signals. As such, channel management algorithms may enable devices to share temporal, frequency, and geographic information related to the presence of fixed and mobile radars to be avoided.

In sum, feedback information that may include device information and/or channel information may be transmitted to a central location, such as a core network or radio access network (e.g., a base station), and analyzed so as to enable the provision of channel status information and channel recommendations to other devices for purposes of channel management for interference reduction.

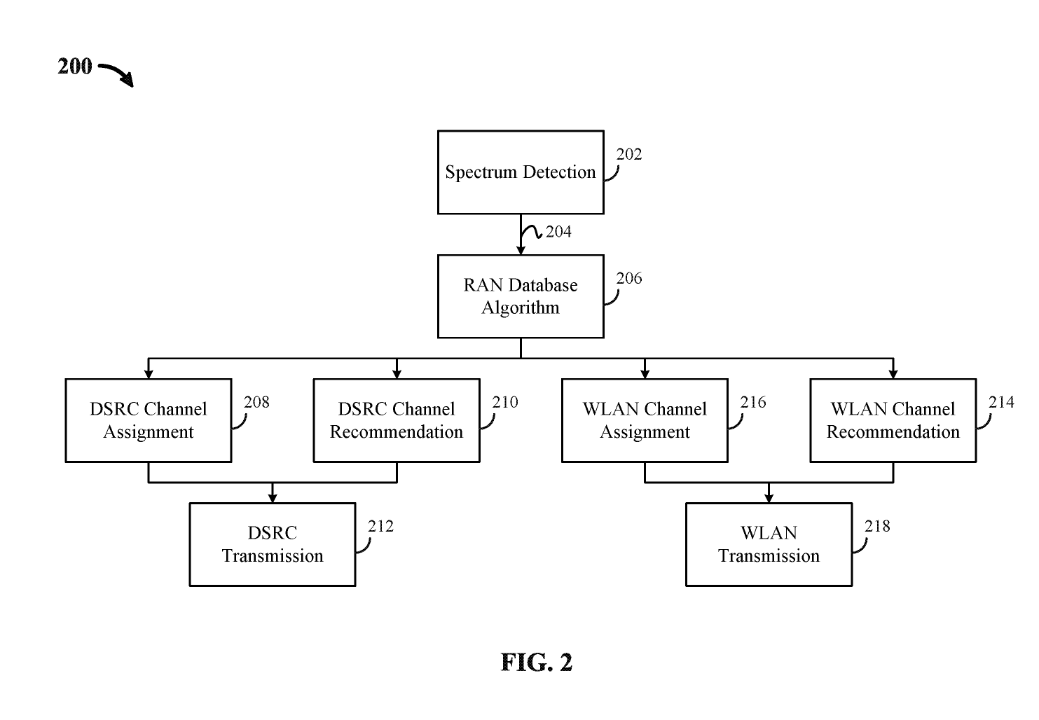

FIG. 2 is an exemplary high level flow diagram 200 of a method of channel management for DSRC and Wi-Fi. In-device and network based algorithms may be used to advantageously coordinate operation of devices using DSRC and Wi-Fi channels. Wireless devices (e.g., a STA or on-board units in vehicles) may perform spectrum detection (at 202) to determine whether one or more channels contains radar signals (if the channels is in the 5 GHz band), wireless activity (e.g., Wi-Fi or DSRC signals), and/or other channel noise. In an aspect, the wireless devices may perform a channel availability check (CAC) every 60 seconds (or up to 10 minutes) on certain channels at startup and build a list of scanned channels found to be free of radar and found to contain radar based on the radar detect algorithms and the rules required for a current geography of operation. Furthermore, during normal operation, the wireless device may continue to scan for radar on a current channel of operation (and may be allowed to scan on alternate channels in some regulatory domains). This in-service-monitoring (ISM) may also result in the identification of radars signals on the current channel that was previously thought to be free of radar. In another aspect, wireless devices seeking to use Wi-Fi channels in other frequencies (e.g., 2.4 GHz channels) may not perform radar detection. Similarly, wireless devices requesting to use DSRC channels may not perform radar detection.

Based on in-device algorithms, wireless devices may collect radar detection data (e.g., timestamp of radar detection, frequency boundaries of detected radar, geographic location of the wireless device, and characteristics of the detected radar pulses/patterns). The radar detection data may be collected by all wireless devices operating in a small or large cell and communicated back to the radio network (or core network) using whichever radio is available at the time of detection (e.g., WLAN, LTE, unlicensed LTE). Additionally, the presence and characteristics of other wireless communications (e.g., from BSSs) may be collected and transmitted (at 204) to a central database, for example.

The radio network (at 206) may receive and store the radar detection data in a database and process the radar detection data (e.g., radar data and presence of other WLAN BSSs in the area) using one or more algorithms. The algorithms may enable the radio network to determine, on a cell-by-cell basis, which channels are currently free from radar, have radar, and/or have other wireless signals. The algorithms may enable the radio access network to generate advisory data to indicate as to which channels a device need not perform CAC because radar was already detected and which channels that are free from radar are optimum for DSRC and/or Wi-Fi use.

Furthermore, the radio network may be able to track and coordinate current Wi-Fi and/or DSRC channels of operation of wireless devices and perform active network planning by sending messages to wireless devices with recommended channels to commence Wi-Fi or DSRC communication. The mixed environment may be supported by wireless devices reporting the presence of other Wi-Fi BSSs (including received signal strength indicators (RSSIs) and service set identifications (SSIDs)) to deduce approximate location of non-reporting devices. For example, at 208, the radio network may provide DSRC channel assignments to wireless devices, and at 210, the radio network may provide DSRC channel recommendations to wireless devices. At 212, upon receiving the recommendations and/or assignments, the wireless devices may initiate DRSC transmissions. Similarly, at 214, the radio network may provide WLAN channel recommendations to wireless devices (e.g., via a local access point), and at 216, the radio network may provide WLAN channel assignments to wireless devices. At 218, upon receiving the recommendations and/or assignments, the wireless devices may initiate WLAN transmissions.

Alternate implementations of channel management may be accomplished using device to device operation. A first wireless device may collect radar and non-radar signal data and include such data in WLAN/DSRC transmissions. A second wireless device in the area may decode the data in the WLAN or DSRC transmission without connecting to the cellular radio network and pass on the first wireless device's data and similar data collected by the second wireless device in a WLAN/DSRC transmission by the second wireless device. In this aspect, a type of mesh sharing of spectrum availability information may be implemented for devices operating within a bounded area.

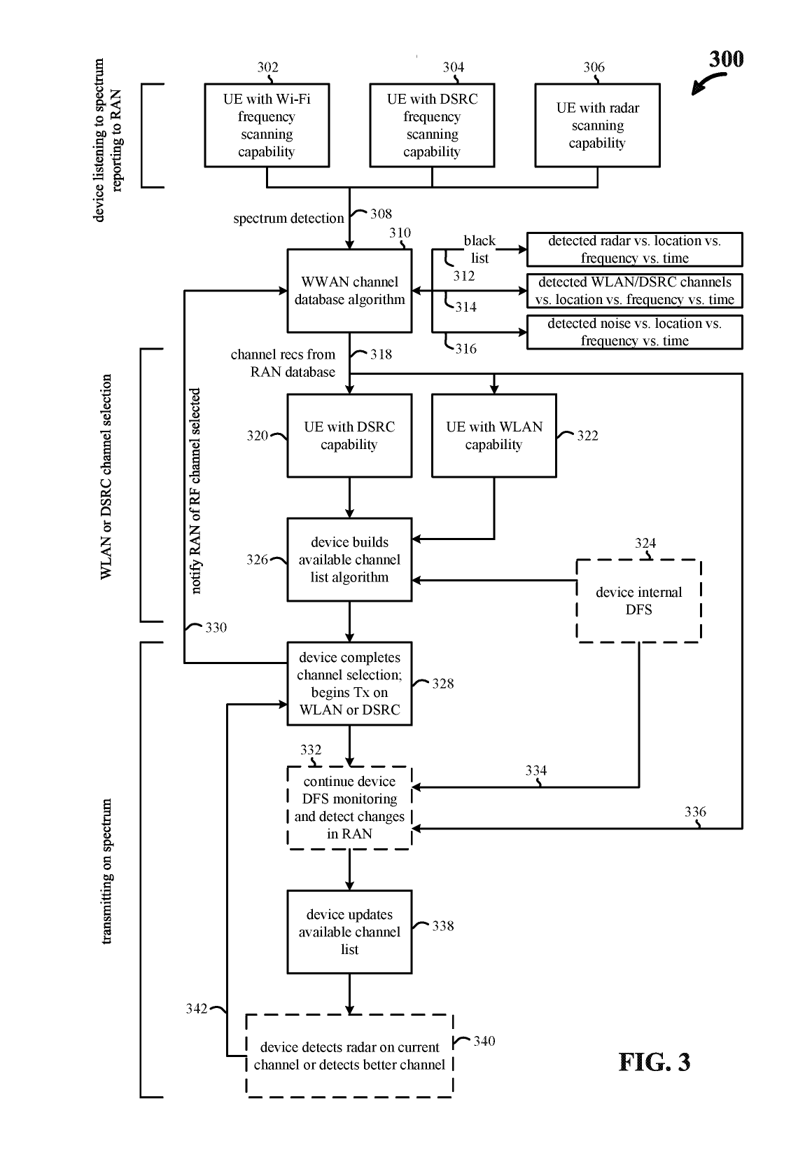

FIG. 3 is an exemplary detailed flow diagram 300 of a method of channel management for DSRC and Wi-Fi. Initially, wireless devices may listen to a Wi-Fi (at 302) and/or DSRC spectrum (at 304) and report data to a radio access network. Wireless devices with 5 GHz frequency scanning capability may also scan for radars (at 306). The scanned/detected information from each of the wireless devices may be provided (at 308) to a WWAN radio network. The WWAN radio network may store the received scanning data and subject the data to one or more algorithms (at 310) for purposes of determining channel status information and providing channel recommendations. In one aspect, the data (at 312) may indicate that radar is detected at a particular geographical location (e.g., a cell ID) at a certain frequency/channel at a particular time. In this aspect, the algorithm may temporarily black list the channel by not making the channel available for communication in Wi-Fi until updated data indicating that no radar signals are detected and a predetermined time period has elapsed. In another aspect, the data (at 314) may indicate that WLAN and/or DSRC communications are detected on one or more channels/frequencies at a particular geographical location at a specific time. In this aspect, the algorithm may assign a channel desirability value (CDV) to the channel, and the channel desirability value may be associated with a timestamp. The timestamp may be a time at which the CDV is assigned or a time at which the WLAN or DSRC communication was detected on the channel. In yet another aspect, the data (at 316) may indicate that noise is detected on a particular channel/frequency at a particular geographical location and at a particular time. In this aspect, the algorithm may assign a channel desirability value to the channel based on the detected noise. In an aspect, the CDV may be based on the detected noise and the detected WLAN/DSRC activity. Based on the received data from the various devices, the radio network may determine for one or more channels in the Wi-Fi and/or DSRC spectrum, whether the one or more channels has radar, WLAN/DSRC activity, and/or noise. Based on this determination, the radio network may provide (at 318) Wi-Fi and/or DSRC channel status information and channel recommendations to wireless devices. Wireless devices (e.g., UEs 320, 322) receiving channel status information and channel recommendations from the radio network may build an available channel list. Wireless devices may avoid channels that are known to have radar signals or high levels of wireless activity or noise. Wireless devices may perform DFS (at 324) on candidate 5 GHz Wi-Fi channels before selecting a 5 GHz Wi-Fi channel for communication. Based on the received channel recommendations and DFS, the wireless devices may build an available channel list (at 326). Subsequently, the wireless devices may select (at 328) the channel(s) to be used for DSRC and/or WLAN transmission and transmit (at 330) information indicating the selected channel(s) to the radio network. While operating on the selected channel, the device may continue to perform ISM on the channel (at 332) to determine whether radar signals are found on the channel if the channel is a 5 GHz Wi-Fi channel (at 334). Wireless devices may receive (at 336) updated channel status information and updated channel recommendations from the radio network. Based on the updated channel status information and updated channel recommendations, wireless devices may update (at 338) the availability channel list. In an aspect, if a new channel with better conditions is found by the network (e.g., less Wi-Fi activity or channel noise) as determined by the updated channel list (at 340), a wireless device may be instructed to move the new channel (at 342). In another aspect, if radar is detected on the current channel (at 340), the wireless device may move to a different channel (at 342) for data transmission to avoid radar signals.

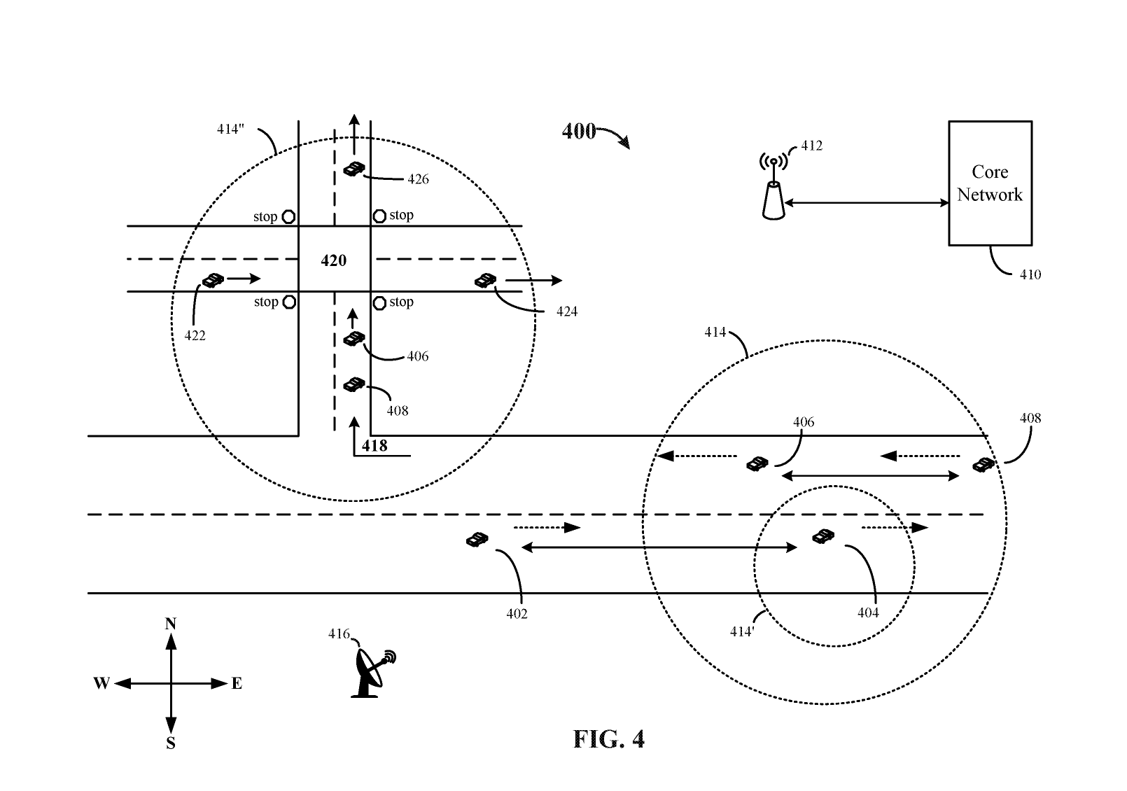

FIG. 4 is an exemplary diagram 400 of a wireless network employing channel management for DSRC and Wi-Fi. Referring to FIG. 4, wireless devices 402, 404 (shown as vehicles but could be other types of devices) are traveling eastbound, and wireless devices 406, 408 (shown as vehicles, for example) are traveling westbound. The wireless devices 402, 404, 406, 408 may be communicating using one or more WLAN and/or DSRC channels. For example, the wireless devices 406, 408 may be communicating with each other over a DSRC channel and have WLAN communications, and the wireless devices 402, 404 may be communicating over WLAN channels. The wireless device 402, 404, 406, 408 may be capable of communicating via WLAN and/or DSRC channels.

In an aspect, the wireless device 402, 404, 406, 408 may each provide feedback reports to a core network 410 via a base station 412 (e.g., an evolved Node B or eNB). The feedback reports may be transmitted to a server via the core network 410. Each feedback report may include device information regarding each of the wireless devices 402, 404, 406, 408. The device information may identify at least one channel on which a wireless device is communicating. For example, the feedback report from the wireless device 406 may identify a DSRC and a WLAN channel on which the wireless device 406 is communicating. The feedback report from the wireless device 404 may identify a WLAN channel on which the wireless device 404 is communicating.

Device information in the feedback reports may include additional information about the wireless device. The device information may include a device identifier identifying the wireless device, a geographical position of the wireless device (e.g., a cell ID associated with the wireless device or GPS coordinates of the wireless device), a speed at which the wireless device is traveling, and/or a direction (e.g., westward) at which the wireless device is moving. The device information may include device capabilities, such as whether the wireless device is capable of communicating over 2.4 GHz WLAN, 5 GHz WLAN, and/or DSRC. The feedback report may indicate a time at which the feedback reported was transmitted or generated by the wireless device. The feedback report may indicate a modulation type and/or MCS for the WLAN channel or the DSRC channel on which the wireless device operates or communicates.

In another aspect, wireless devices may receive device information from neighboring wireless devices (e.g., via DSRC communications) and transmit device information associated with one or more neighboring wireless devices. Referring to FIG. 4, the wireless device 406 may receive device information from nearby wireless devices 404, 408. In this aspect, the feedback report from the wireless device 406 may include device information from the wireless devices 404, 406, 408. This feature may be useful when the wireless devices 404, 408 may not be able to access the WAN for purposes for transmitting feedback reports.

In another aspect, the wireless devices may scan WLAN and/or DSRC channels to determine an amount of wireless activity on the channels. The wireless devices may report the amount of detected wireless activity to the core network 410, for example, for purposes of assisting the core network 410 to perform channel management. For example, for a 2.4 GHz WLAN channel, the wireless device 406 may determine whether any noise or Wi-Fi signals are present. In an aspect, the wireless device 406 may measure an energy detection level on the 2.4 GHz WLAN channel and determine whether the energy detection level is below an energy detection level threshold that would indicate that there is wireless activity on the channel. In another aspect, the wireless device 406 may determine whether the wireless device 406 has received any WLAN preambles on the 2.4 GHz WLAN channel. If no WLAN preambles are received and/or the energy detection level is below the threshold, the wireless device 406 may determine that there is no wireless activity on the channel. The wireless device 406 may repeat this scanning procedure for one or more WLAN channels in the 2.4 GHz range.

Similarly, for a 5 GHz WLAN channel, the wireless device 406 may determine whether any radar signals are present (e.g., from a radar 416). The wireless device 406 may perform a radar scan (e.g., perform a channel availability check or CAC) to identify any channels that contain and/or do not contain radar signals or other signals (e.g., Wi-Fi signals). The wireless device 406 may determine whether any noise or Wi-Fi signals are detected. For example, the wireless device 406 may measure an energy detection level on the 5 GHz WLAN channel and determine whether the energy detection level is below an energy threshold required to indicate that there is wireless activity (e.g., Wi-Fi transmissions) on the channel. In another aspect, the wireless device 406 may determine whether the wireless device 406 has received any WLAN preambles on the 5 GHz WLAN channel. If no WLAN preambles are received and/or the energy detection level is below the threshold, the wireless device 406 may determine that there is no wireless activity on the channel. The wireless device 406 may repeat this scanning procedure for one or more WLAN channels in the 5 GHz range.

For a DSRC channel, the wireless device 406 may determine whether any noise or DSRC signals are present. For example, the wireless device may measure an energy detection level on the DSRC channel and determine whether the energy level is below an energy threshold required to indicate that there is DSRC wireless activity. Alternatively, the wireless device 406 may determine whether any DSRC transmissions from other wireless devices are detected. If no DSRC transmissions are received and/or the energy level is below a threshold, the wireless device may determine that there is no wireless activity on the DSRC channel. The wireless device 406 may repeat this scanning procedure for one or more DSRC channels. Although the aforementioned channel scanning is performed by the wireless device 406, other wireless devices may also perform channel scanning.

In the above examples, the wireless device 406 may determine a CDV for the WLAN and/or DSRC channels based on the measurements and provide a CDV to the core network 410, or wireless device 406 may provide the measurement information to the core network 410 to enable the core network 410 to determine the CDV for each channel.

The wireless device 406 may store (e.g., in a list or table) the results of the channel scans as channel information for various WLAN and/or DSRC channels. In one configuration, channel information as determined for each channel may include one or more of: a time at which radar signal detection was attempted, an indication of whether radar was detected (e.g., a CAC bit indicator, in which CAC=0 if no radar detect, and CAC=1 if radar is detected), a geographical location of the wireless device 406 when radar signal detection was attempted (e.g., a cell ID associated with the base station 412 or GPS coordinates of the wireless device 406), an indication of wireless activity (or the lack of wireless activity) on each of the one or more WLAN and/or DSRC channels, or an indication of channel noise on each of the one or more WLAN and/or DSRC channels. In one aspect, the wireless activity and/or noise may be indicated by a CDV. A CDV may range from 0-9. A CDV of 0 may indicate that the channel is free or nearly free from wireless activity/channel noise and/or does not have any transmissions from other BSSs. By contrast, a channel desirability value of 9 may indicate that the channel is very busy (e.g., the energy detection level is beyond a threshold, the number of received WLAN preambles is beyond a threshold, channel noise is high) and cannot support any additional devices/connections. The CDV may be associated with a channel desirability timestamp that indicates when the CDV was determined by the wireless device 406 or when the channel was measured. In another aspect, the indication of wireless activity may be a channel measurement (e.g., an energy detection level and/or a number of received preambles). In another aspect, the channel information may include the cell IDs associated with the geographical location(s) at which the radar and/or non-radar signal detections were performed.

Each of the wireless devices 402, 404, 406, 408 may transmit a respective feedback report to the core network 410 via the base station 412. For example, the wireless device 406 may transmit a first feedback report that indicates the WLAN and the DSRC channels on which the wireless device 406 is communicating. The first feedback report may include the location of the wireless device 406 and may include a speed and a direction at which the wireless device 406 is moving. The first feedback report may also include channel information (e.g., CDVs) on WLAN and DSRC channels as scanned by the wireless device 406.

The wireless device 408 may transmit a second feedback report that indicates the WLAN and the DSRC channels on which the wireless device 408 is communicating. The second feedback report may include the location of the wireless device 408 and the speed and direction at which the wireless device 408 is moving. The wireless device 402 may transmit a third feedback report that indicates the WLAN channel on which the wireless device 402 is communicating. The third feedback report may include the location of the wireless device 402 and the speed and direction at which the wireless device 402 is moving. The wireless device 404 may transmit a fourth feedback report. The fourth feedback report may indicate the WLAN channel on which the wireless device 404 is communicating. The fourth feedback report may include the location of the wireless device 404 and the speed and direction at which the wireless device 404 is moving. The fourth feedback report may further include channel information on WLAN channels (e.g., 2.4 GHz and/or 5 GHz) as scanned by the wireless device 404.

Upon receiving the first, second, third and fourth feedback reports, the core network 410 may store the channel information and device information included in the feedback reports. The core network 410 may generate and maintain a database of information associated with a cell. With the device and channel information, the core network 410 may manage WLAN and DSRC channel usage.

In performing channel management, the core network 410 may determine when to allow channel reuse based on the geographical locations of wireless devices. For example, a same channel may be reused by wireless devices when the distance between the wireless devices is greater than a distance threshold (e.g., more than 300 meters apart). The distance threshold may be used to define a channel reuse zone. If wireless devices are within a channel reuse zone, then the wireless devices may be assigned different channels as a best effort. However, when the density of wireless devices increases, it may be more difficult to maintain ideal separation. As such, the core network 410 may adjust the channel reuse zone when congestion occurs.

Referring to FIG. 4, the core network 410 (or the base station 412) may associate a channel reuse zone 414 with the wireless device 404. The channel reuse zone 414 may have a 300 meter radius or some other radius. The wireless device 404 may transmit a request, to the core network 410, to communicate using DSRC channels with the wireless device 402. The request may include the location, speed, and direction of the wireless device 404. The request may also indicate device capabilities (e.g., capable for communicating on 2.4 GHz WLAN channels, 5 GHz WLAN channels, and/or DSRC channels). In another aspect, the request may indicate priority information associated with the wireless device 404 (e.g., whether the wireless device 404 is requesting high priority data or is a user authorized to receive priority access to one or more WLAN and/or DSRC channels). For example, emergency calls may be considered high priority data, and emergency personnel or people with preferred status may have priority access. As previously discussed, the wireless devices 406, 408 may be communicating with each other over DSRC channel. Based on the location of the wireless device 404, the core network may determine that the wireless devices 406, 408 are within the channel reuse zone 414 of the wireless device 404. To avoid co-channel interference with the wireless device 406, 408, the core network 410 may determine one or more DSRC channels to recommend or assign/allocate to the wireless device 404. The determination may be based on the location, speed, direction, and/or channel usage of other wireless devices within a cell. In one aspect, the core network 410 may identify a channel that maximizes the geographical distance between the wireless device 404 and the wireless devices 406, 408. In the simplest case, this may entail having devices within the same channel reuse zone utilize different channels. However, when device density increases, different devices within the same channel reuse zone cannot all use a different channel. As such, the core network 410 may adjust the channel reuse zone 414 by reducing the size of the channel reuse zone 414. In the reduced size channel reuse zone 414′, the wireless device 406 is outside of the reduced size channel reuse zone 414′, and thus, the wireless devices 404, 406 may use the same channel.

In another aspect, speed and direction information may be used in addition to location information to predict the channel usage within the requested DSRC communication time period (e.g., a few seconds) and calculate the channel based not only on a present time instant and the wireless device locations at the present time instant but also by taking into account any future co-channel interferers during the future communication time interval. For example, if the wireless devices 404, 406, 408 are moving at high speeds, the core network 410 may determine that although the devices are within the same channel reuse zone 414 at the time of the request, the devices will pass each other shortly (e.g., within 1 second) and will be in different channel reuse zones when DSRC transmissions occur (e.g., within 1 minute). In this example, the core network 410 may assign or suggest the same DSRC channel for use by the wireless devices 404, 406, 408 based on a predicted location of the wireless devices 404, 406, 408. By contrast, if the wireless devices 404, 406, 408 are stopped or are approaching each other at slow speeds, then the core network 410 may determine that the wireless devices may remain in the same channel reuse zone 414 when the DSRC communication occurs, and therefore, the core network 410 may assign or allocate one or more different DSRC channels to the wireless device 404 than the one used by the wireless devices 406, 408. Upon receiving one or more available DSRC channels as provided by the core network 410, the wireless device 404 may select from the available DSRC channels and transmit a message to the core network 410 indicating the selected channel.

In another aspect, the DSRC channel assignment may also be based on CDVs. For example, the core network 410 may allocate a DSRC channel to the wireless device 404 based on the location of the wireless device 404 and based on the CDVs of the available set of DSRC channels. The core network 410 may allocate a channel that is not in use within the channel reuse zone 414 and that has the best channel quality (or lowest CDV) among the available DSRC channels. Although the aforementioned examples discuss the assignment of DSRC channels, the teachings and principles are also applicable to WLAN channels.

Referring again to FIG. 4, at a corner 418, the wireless devices 406, 408 may turn right and approach an intersection 420 with a four-way stop sign. A wireless device 422 may be approaching the intersection 420. Wireless devices 424, 426 may be moving away from the intersection 420. The wireless device 424 may be traveling in a direction that is perpendicular to the direction of travel associated with the wireless device 406, whereas the wireless device 426 may be traveling in parallel with the direction associated with the wireless device 406.

Because the wireless device 406 changed directions, the wireless device 406 may transmit an update message to the core network 410 to update the device information associated with the wireless device 406. For example, the update message may indicate a position of the wireless device 406, a speed at which the wireless device 406 is moving, a direction at which the wireless device 406 is moving, and/or one or more WLAN/DSRC channels on which the wireless device 406 is communicating. Based on the received update message, the core network 410 may determine that the wireless devices 406, 422 are communicating on the same WLAN channel and that the wireless device 422 is in the same channel reuse zone 414″ as the wireless device 406. As such, the core network 410 may allocate a different set of WLAN channels from which the wireless device 406 may select. The core network 410 may determine that wireless devices 424, 426 are also within the channel reuse zone 414″. The channel allocation may also be based on the location, speed, and direction of the wireless devices 424, 426 as well as any WLAN channels that the wireless devices 424, 426 are communicating. For example, the core network 410 may determine that the wireless device 424, while in the same channel reuse zone 414″, is moving away from the wireless device 406 and will soon be outside of the channel reuse zone 414″. As such, the core network 410 may decide to include a WLAN channel used by the wireless device 424 in the set of channel allocations for the wireless device 406. Also, the core network 410 may determine that the wireless devices 406, 426 are not only located in the same channel reuse zone 414″ but also are moving in the same direction, which increases the likelihood of co-channel interference. As such, the core network 410 may exclude the WLAN channel on which the wireless device 426 is communicating from the set of channels to be allocated to the wireless device 406. Similarly, the core network 410 may exclude the WLAN channel on which the wireless device 408 is communicating from the set of channels to be allocated to the wireless device 406 because the wireless devices 406, 408 are within the same channel reuse zone and are moving in the same direction. After determining the set of channels to allocate to the wireless device 406, the core network 410 may transmit a channel move request to the wireless device 406, and the channel move request may include the allocated set of channels. The wireless device 406 may select a WLAN channel from the allocated set of channels and transmit a message to the core network 410 indicating the selected WLAN channel. Although the aforementioned example is associated with WLAN channels, the teachings and principles are also applicable to DSRC channels.

In an aspect, a WLAN or DSRC channel may be allocated (or excluded from allocation) based on an admission policy. Certain classes of users or types of applications may be associated with an admission policy. For example, if a user pays a subscription fee for higher bandwidth, a user may have higher priority for channels of higher quality and may be less likely to be asked to move to a different channel. By contrast, a user who does not pay a subscription fee may be more likely to be asked to be moved to a different channel. In other cases, public safety personnel may have the highest user priority and may be able to access WLAN and/or DSRC channels that are excluded by use from others (e.g., when there is an emergency event). In another example, certain applications such as video streaming may have higher priority than other application such as file transfers or texting applications. In another example, users who have already been granted access to a channel may be given preference over a channel compared to users who are request to communicate on a channel. The core network 410 may allocate channels based in part on the admission policy.

In another aspect, a channel allocation may refer to both frequency channels and time slots within the same frequency channel. For example, different wireless devices may be granted access to different frequency channels. In another example, different wireless devices may be granted access to a same frequency channel but at different time slots.

In the aforementioned examples, any principles, teachings, and/or techniques discussed with respect to WLAN channels may be also be applicable to DSRC channels and vice versa.

In another aspect, channel allocated provided to devices within a cell may include channel assignments and/or recommendations. Channel assignments may refer to a set of channels that a device is required to select from, and channel recommendations may refer to a set of channels that the device is recommended to select from.

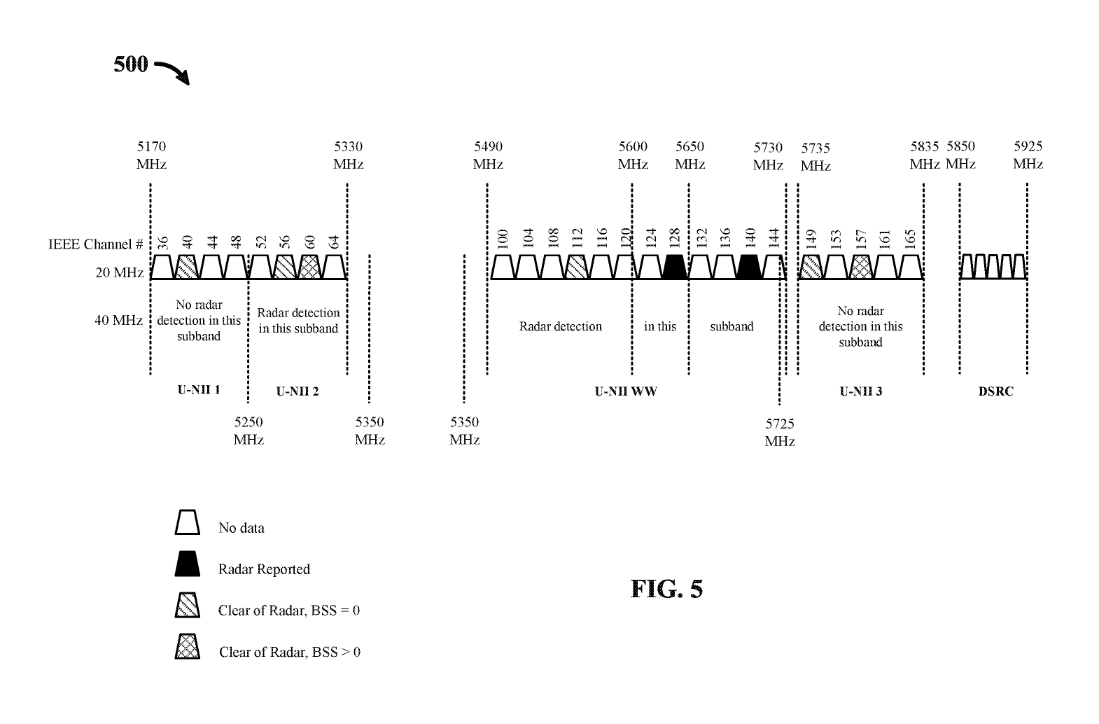

FIG. 5 illustrates an exemplary channel map 500 for a single cell in a radio access network. Referring to FIG. 5, a sample status snapshot of all the 5 GHz U-NII channels is shown. As shown in FIG. 5, the 5 GHz U-NII channels operate over four ranges: U-NII 1, U-NII 2, U-NII World Wide, and U-NII 3. U-NII 1 may be limited to indoor use. U-NII 2 may be used in both outdoor and indoor environments, subject to DFS or radar avoidance. U-NII 2 may be used in both outdoor and indoor environments, subject to DFS or radar avoidance. U-NII 3 bands were originally allocated for industrial, scientific, and medical purposes but are increasingly used for telecommunications. Radar detection is required in U-NII 2 and U-NII WW but not in U-NII 1 or U-MI 3. FIG. 5 also illustrates a set of DSRC channels which may operate in the frequency range between 5850 megahertz (MHz) to 5925 MHz.

Referring to FIG. 5, assuming a channel bandwidth of 20 MHz, IEEE channel numbers 36, 40, 44, 48, 52, 56, 60, 64, 100, 104, 108, 112, 116, 120, 124, 128, 132, 136, 140, 144, 149, 153, 157, 161, and 165 are provided. Each channel may be associated with a channel status: no data, radar reported, clear of radar and BSS=0, clear of radar and BSS>0. In an aspect, the BSS may be a channel desirability value that indicates a level of wireless activity on a channel. As shown in FIG. 5, channels 36, 44, 48, 52, 64, 100, 104, 108, 116, 120, 124, 132, 136, 144, 153, 161, and 165 may have no channel data because the core network 436 has not received any feedback reports associated with those channels. Channels 128 and 140 may have radar reported. For example, the wireless device 402 and the wireless device 404 may have performed CAC and detected radar signals on channels 128 and 140. The wireless devices 402, 404 may have reported the channel information for channels 128 and 140 in a feedback report to the core network 410. The core network 410 may indicate that channels 128 and 140 have radar signals based on the received feedback reports. Channels that have radar typically do not have any non-radar wireless activity because wireless devices would be prohibited from transmitting on channels with radar signals due to DFS requirements. Furthermore, the wireless device 402 may determine that channels 40, 56, 112, and 149 are clear of radar and have little to no wireless activity (e.g., channel desirability value or BSS=0). The wireless device 402 may further determine that channels 60 and 157 are clear of radar but have wireless activity above a threshold (e.g., channel desirability value or BSS>0). As such, the wireless device 402 may transmit the channel information for channels 40, 56, 60, 112, 157, and 149 in a feedback report to the core network 410. The core network 410 may update the channel information accordingly. In aspect, channels 124 and 128 may be allocated for weather radar usage, and thus, channels 124 and 128 may be avoided if possible.

As shown in FIG. 5, only 20 MHz IEEE channels are used for WLAN channels because radar signals are typically bounded within one or two such channels. Wireless devices may derive which 40, 80, and 160 MHz channels to attempt operation based on the 20 MHz channel data provided by the core network 410. As such, the core network 410 need not consider higher bandwidth IEEE channels when compiling the real-time table and when providing channel recommendations. With respect to channel recommendations, if WLAN access is only allowed in U-NII 3 upper 5 GHz band, the core network 410 may recommend channels (e.g., channels clear of radar with BSS=0) for WLAN in the U-NII 1 bands (because no radar detection is required), then next recommend channels in U-NII 2. This steers wireless devices to use available channels free of radar but reserves operation in the channels associated with an admission policy for potential use in the near term.

With respect to the DSRC channels, 10 MHz channels may be used. Although FIG. 5 depicts 5 different DSRC channels, another number of DSRC channels may be used, and such DSRC channels may have a channel bandwidth different from 10 MHz.

In an aspect, the channel map may be continuously updated and made available to all wireless devices in a cell. In an aspect, the core network 410 may provide the channel map as status information to various wireless devices. Channel status information provided by the core network 410 may include an indication of the allocated set of channels and/or at least some of the information in the channel map as shown in FIG. 5.

These channel numbers are exemplary and provided for the purposes of illustrating the channel map 500. Other channel numbers corresponding to the same or different channel bandwidths at the same or different frequency bands may also be used.

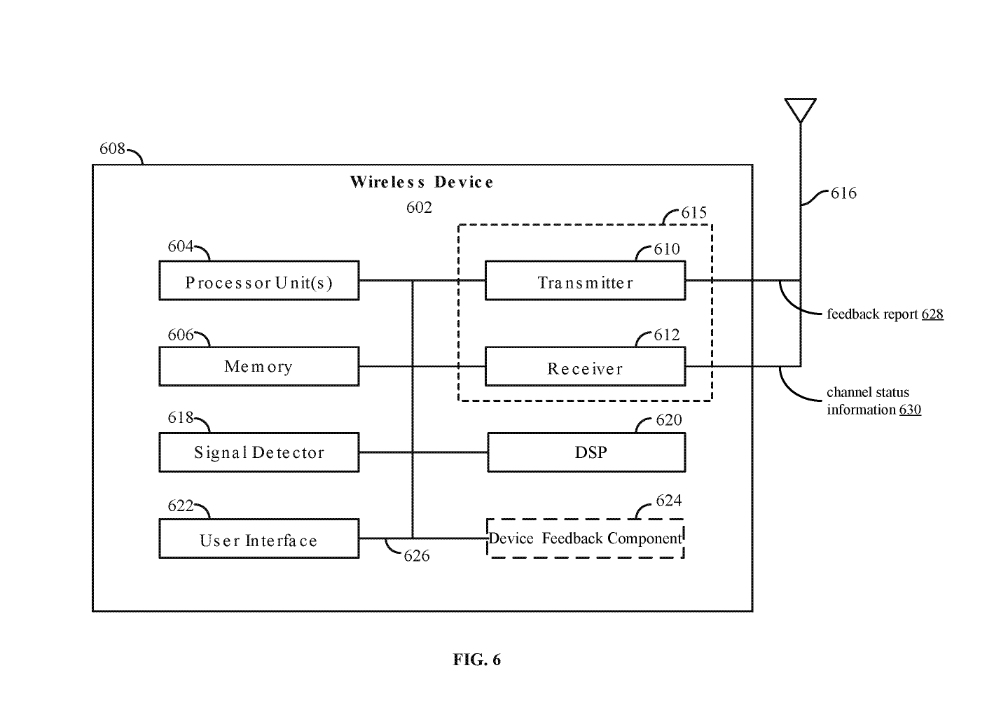

FIG. 6 shows an example functional block diagram of a wireless device 602 that may provide feedback reports and receive channel status information within the wireless communication system 100 of FIG. 1. The wireless device 602 is an example of a device that may be configured to implement the various methods described herein. For example, the wireless device 602 may comprise one of the one of the STAs 112, 114, 116, 118 or one of the wireless devices 402, 404, 406, 408.

The wireless device 602 may include a processor 604 which controls operation of the wireless device 602. The processor 604 may also be referred to as a central processing unit (CPU). Memory 606, which may include both read-only memory (ROM) and random access memory (RAM), may provide instructions and data to the processor 604. A portion of the memory 606 may also include non-volatile random access memory (NVRAIVI). The processor 604 typically performs logical and arithmetic operations based on program instructions stored within the memory 606. The instructions in the memory 606 may be executable (by the processor 604, for example) to implement the methods described herein.

The processor 604 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 602 may also include a housing 608, and the wireless device 602 may include a transmitter 610 and/or a receiver 612 to allow transmission and reception of data between the wireless device 602 and a remote device. The transmitter 610 and the receiver 612 may be combined into a transceiver 614. An antenna 616 may be attached to the housing 608 and electrically coupled to the transceiver 614. The wireless device 602 may also include multiple transmitters, multiple receivers, multiple transceivers, and/or multiple antennas.

The wireless device 602 may also include a signal detector 618 that may be used to detect and quantify the level of signals received by the transceiver 614 or the receiver 612. The signal detector 618 may detect such signals as total energy, energy per subcarrier per symbol, power spectral density, and other signals. The wireless device 602 may also include a digital signal processor (DSP) 620 for use in processing signals. The DSP 620 may be configured to generate a packet for transmission. In some aspects, the packet may comprise a physical layer convergence procedure (PLCP) protocol data unit (PPDU).

The wireless device 602 may further comprise a user interface 622 in some aspects. The user interface 622 may comprise a keypad, a microphone, a speaker, and/or a display. The user interface 622 may include any element or component that conveys information to a user of the wireless device 602 and/or receives input from the user.

When the wireless device 602 is implemented as a STA (e.g., the STA 114 or the wireless device 404), the wireless device 602 may also comprise a device feedback component 624. In one configuration, the device feedback component 624 may be configured to determine device information associated with the wireless device 602, in which the device information identifies at least one channel on which the wireless device 602 is communicating, and the at least one channel is a WLAN channel and/or a DSRC channel. The device feedback component 624 may be configured to transmit a feedback report (e.g., a feedback report 628) that includes the device information over a WAN connection. In another aspect, the device information may include at least one of a device identifier associated with the wireless device 602, a position of the wireless device 602, a speed at which the wireless device 602 is moving, and/or a direction in which the wireless device 602 is moving. In another configuration, the feedback report may indicate at least one of a time at which the feedback report was transmitted or a modulation type for each of the WLAN channels or the DSRC channels on which the wireless device 602 is communicating. In another configuration, the device feedback component 624 may be configured to receive additional device information associated with at least one other wireless device, and the feedback report may further include the additional device information associated with the at least one other wireless device. In another configuration, the device feedback component 624 may be configured to determine an amount of activity on wireless channels by determining a first amount of activity on one or more WLAN channels and by determining a second amount of activity on one or more DSRC channels. In this configuration, the feedback report may indicate the amount of activity on the wireless channels. In another configuration, the device feedback component 624 may be configured to transmit a request to communicate on a WLAN channel and/or a DSRC channel, and the request may include at least one of a position of the wireless device 602, a speed at which the wireless device 602 is moving, and/or a direction in which the wireless device 602 is moving. In this configuration, the device feedback component 624 may be configured to receive channel status information (e.g., channel status information 630) based on the transmitted request, and the channel status information may indicate at least one of an allocated WLAN channel and/or an allocated DSRC channel. The device feedback component 624 may be configured to select a channel based on the received channel status information. In another configuration, the device feedback component 624 may be configured to transmit a message indicating the selected channel on which the wireless device 602 is communicating. In another configuration, the device feedback component 624 may be configured to update device information associated with the wireless device 602, and the device information may include at least one of the position of the wireless device 602, the speed at which the wireless device 602 is moving, and/or the direction in which the wireless device 602 is moving. In this configuration, the device feedback component 624 may be configured to transmit the updated device information and to receive a channel move request based on the updated device information.

The various components of the wireless device 602 may be coupled together by a bus system 626. The bus system 626 may include a data bus, for example, as well as a power bus, a control signal bus, and a status signal bus in addition to the data bus. Components of the wireless device 602 may be coupled together or accept or provide inputs to each other using some other mechanism.

Although a number of separate components are illustrated in FIG. 6, one or more of the components may be combined or commonly implemented. For example, the processor 604 may be used to implement not only the functionality described above with respect to the processor 604, but also to implement the functionality described above with respect to the signal detector 618, the DSP 620, the user interface 622, and/or the device feedback component 624. Further, each of the components illustrated in FIG. 6 may be implemented using a plurality of separate elements.

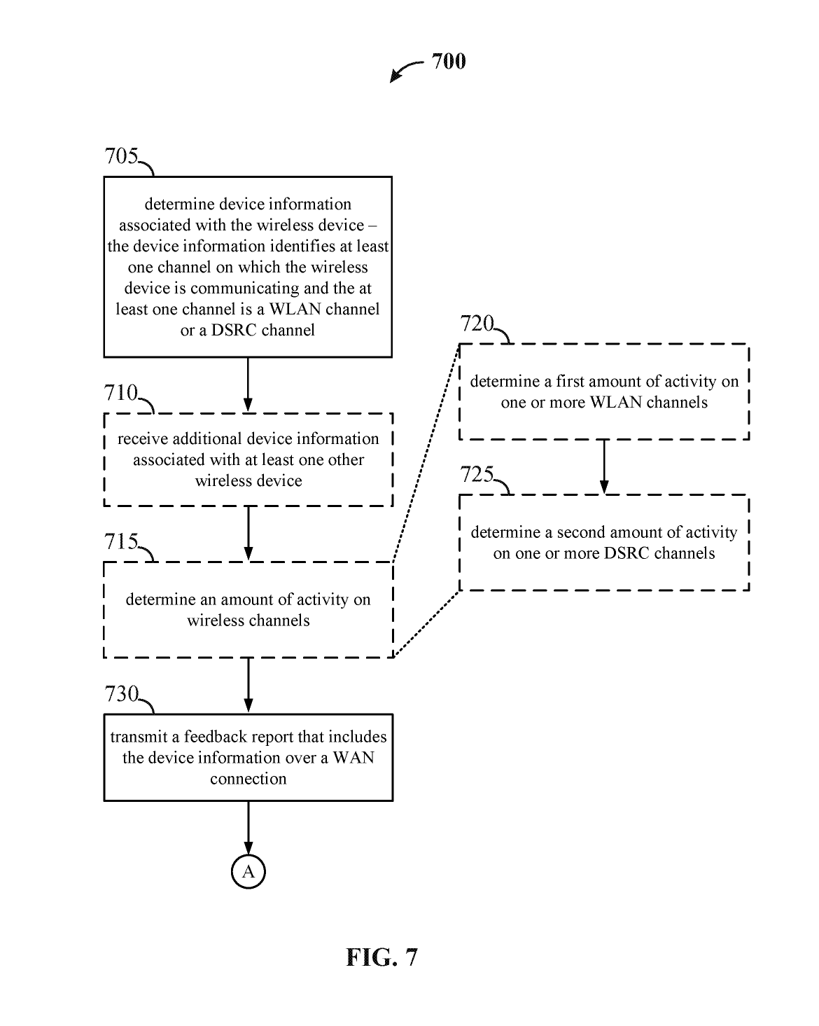

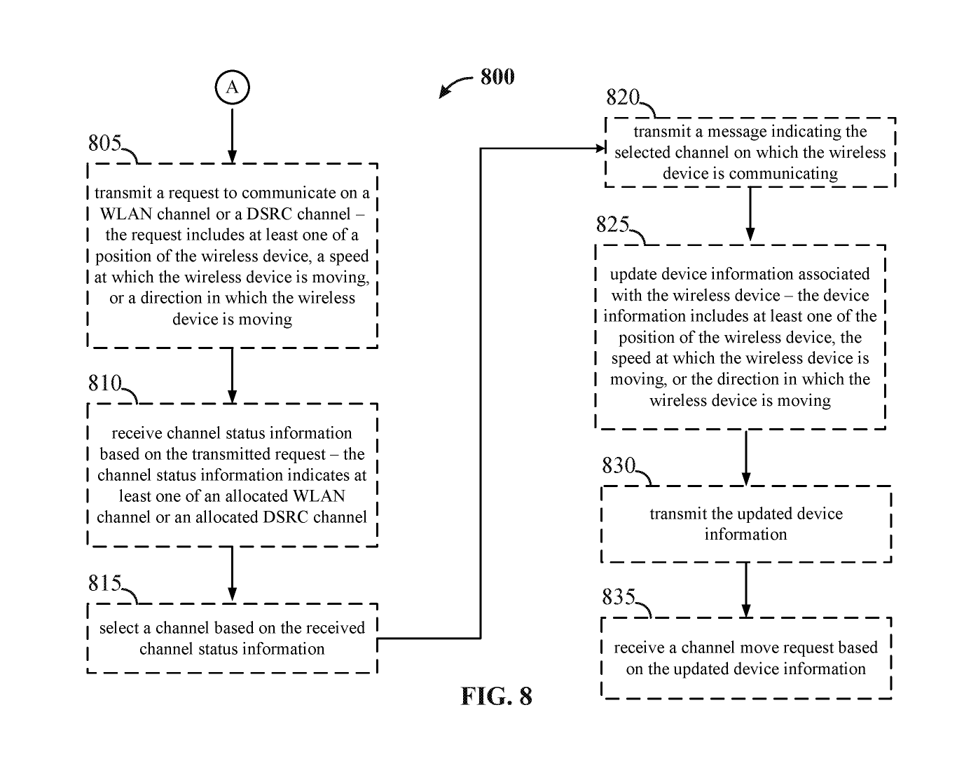

FIGS. 7 and 8 are flowcharts of example methods 700, 800 for providing feedback for channel management and for selecting a Wi-Fi and/or DSRC channel for communication based on network channel management. The methods 700, 800 may be performed using an apparatus (e.g., the STA 114, the wireless devices 402, 404, 406, 408, or the wireless device 602, for example). Although the methods 700, 800 are described below with respect to the elements of wireless device 602 of FIG. 6, other components may be used to implement one or more of the steps described herein.

At block 705, the apparatus may determine device information associated with the apparatus. The device information may identify at least one channel on which the apparatus is communicating and the at least one channel is a WLAN channel or a DSRC channel. In another aspect, the device information may also include at least one of a device identifier associated with the apparatus, a position of the apparatus, a speed at which the apparatus is moving, or a direction in which the apparatus is moving. For example, referring to FIG. 4, the wireless device 404 (which correspond to the apparatus) may determine device information associated with the wireless device 404. The wireless device 404 may determine whether the wireless device 404 is communicating on a WLAN channel and/or a DSRC channel. If the wireless device 404 is communicating on either a WLAN or a DSRC channel, then the wireless device 404 may identify the WLAN and/or the DSRC channel on which the wireless device is communicating. The wireless device 404 may also determine a device identifier associated with the wireless device (e.g., all or part of a medium access control (MAC) address). The wireless device 404 may determine a position of the wireless device 404 based on GPS technology within the wireless device 404 or based on an association with a base station (e.g., a cell ID). The wireless device 404 may also determine a speed and/or direction in which the wireless device 404 is moving based on GPS information (e.g., GPS coordinates) or other motion sensing equipment within the wireless device 404.

At block 710, the apparatus may receive additional device information associated with at least one other wireless device. For example, referring to FIG. 4, the wireless device 404 may receive device information associated with the wireless devices 406, 408. The device information associated with each of the wireless devices 406, 408 may include a device identifier, location, speed, and direction information, and/or at least one WLAN or DSRC channel on which the wireless device is communicating. In an aspect, the device information from the wireless devices 406, 408 may be received over DSRC channels.

At block 715, the apparatus may determine an amount of activity on wireless channels. The apparatus may determine the amount of activity by determining a first amount of activity on one or more WLAN channels (at block 720) and by determining a second amount of activity on one or more DSRC channels (at block 725). For example, referring to FIGS. 4 and 5, the wireless device 404 may measure the energy detection level on multiple WLAN channels and on multiple DSRC channels. The WLAN channels and the DSRC channels may be from the set of channels shown in FIG. 5. The wireless device 404 may attempt to detect WLAN preambles on multiple WLAN channels and detect DSRC transmission on multiple DSRC channels. If the wireless device 404 detects WLAN preambles, the wireless device 404 may count the number of WLAN preambles detected on each of the WLAN channels.

At block 720, the apparatus may transmit a feedback report that includes the device information over a WAN connection. In an aspect, the feedback report may indicate at least one of a time at which the feedback report was transmitted or a modulation type for each of the WLAN channels or the DSRC channels on which the wireless device is communicating. For example, referring to FIG. 4, the wireless device 404 may transmit a feedback report that includes the device information to the core network 410 via the WAN connection with the base station 412. The feedback report may indicate a time at which the wireless device 404 transmitted the feedback report. The feedback report may indicate the modulation type for the WLAN and DSRC channels on which the wireless device 404 is communicating. The feedback report may further include device information associated with the wireless devices 406, 408. The feedback report may also indicate the amount of WLAN and DSRC channel activity (e.g., an energy detection level or a number of detected preambles) on various channels as detected by the wireless device 404.

Referring to FIG. 8, at block 805, the apparatus may transmit a request to communicate on a WLAN channel or a DSRC channel. The request may include at least one of a position of the wireless device, a speed at which the wireless device is moving, or a direction in which the wireless device is moving. For example, referring to FIG. 4, the wireless device 404 may transmit a request to communicate on a WLAN channel and a DSRC channel to the core network 410 via the base station 412. The request may include the position of the wireless device 404, the speed at which the wireless device 404 is moving, and the direction in which the wireless device 404 is moving.

At block 810, the apparatus may receive channel status information based on the transmitted request. The channel status information may indicate at least one of a recommended WLAN channel or a recommended DSRC channel. For example, referring to FIG. 4, the wireless device 404 may receive channel status information from the core network 410 based on the transmitted request. The channel status information may indicate two WLAN channels and one DSRC channel that the wireless device 404 may use to communicate.

At block 815, the apparatus may select a channel based on the received channel status information. For example, referring to FIG. 4, the wireless device 404 may select one of the two WLAN channels and the DSRC channel to use for communication. In an aspect, if the channel status information indicates channel quality information of the WLAN channel, for example, the wireless device 404 may determine which channel has the best channel quality and select the channel with the best quality (e.g., a channel corresponding to the highest supported modulation and coding scheme (MCS) rate).

At block 820, the apparatus may transmit a message indicating the selected channel on which the wireless device is communicating. For example, referring to FIG. 4, the wireless device may transmit a message to the core network 410 that indicates the selected WLAN and/or DSRC channel on which the wireless device 404 is communicating.

At block 825, the apparatus may update device information associated with the wireless device. The device information may include at least one of the position of the wireless device, the speed at which the wireless device is moving, or the direction in which the wireless device is moving. For example, referring to FIG. 4, the wireless device 404 may determine that the wireless device 404 has changed a direction of travel and/or a speed of travel (e.g., similar to the wireless device 406 making a right turn at the corner 418). The wireless device 404 may determine a new speed of travel, direction of travel, and/or position associated with the wireless device 404.

At block 830, the apparatus may transmit the updated device information. For example, referring to FIG. 4, the wireless device 404 may transmit the updated device information regarding updated position, speed, and or direction information associated with the wireless device 404. The updated device information may enable the core network 410 to perform channel management for WLAN and/or DSRC communications by adjusting the channel allocation for one or more wireless devices.

At block 835, the apparatus may receive a channel move request based on the updated device information. For example, referring to FIG. 4, the wireless device 404 may receive a channel move request based on the updated device information. The channel move request may indicate a new set of allocated WLAN and/or DSRC channels on which the wireless device 404 may communicate.

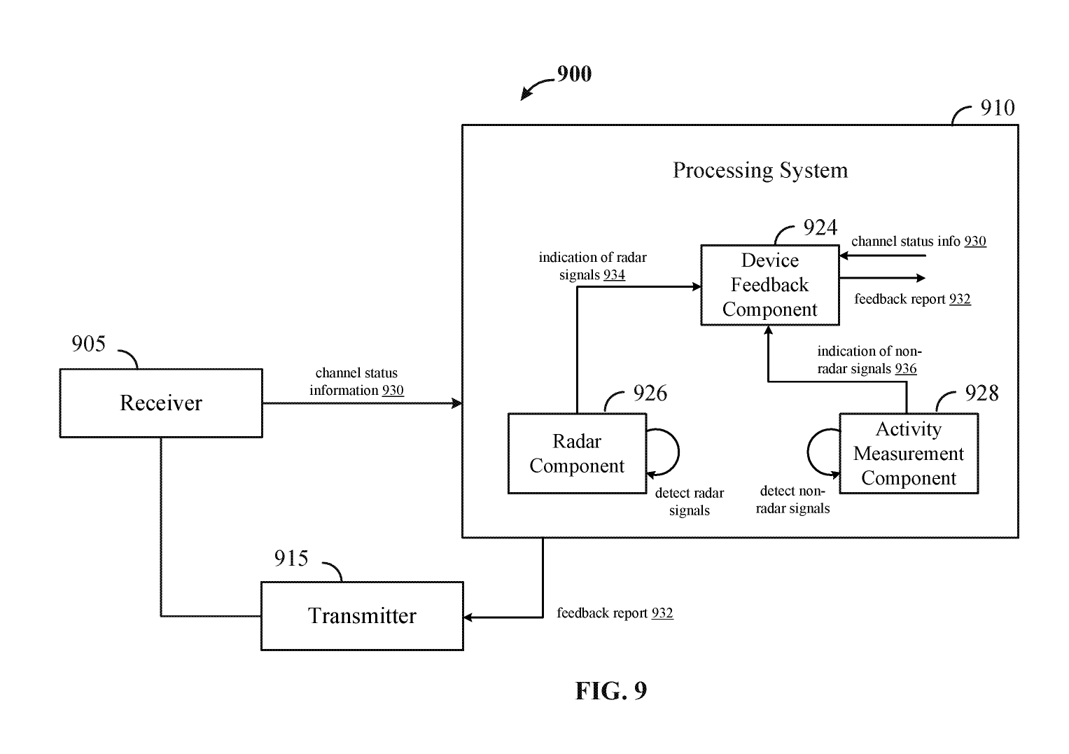

FIG. 9 is a functional block diagram of an example wireless communication device 900 that may provide feedback reports and receive channel status information for WLAN and/or DSRC channels. The wireless communication device 900 may include a receiver 905, a processing system 910, and a transmitter 915. The processing system 910 may include a device feedback component 924, a radar component 926, and/or an activity measurement component 928. In one configuration, the processing system 910 and/or the device feedback component 924 may be configured to determine device information associated with the wireless communication device 900. The device information may identify at least one channel on which the wireless communication device 900 is communicating, and the at least one channel may be a WLAN channel or a DSRC channel. The processing system 910 and/or the transmitter 915 may be configured to transmit a feedback report (e.g., a feedback report 932) that includes the device information over a WAN connection. In an aspect, the device information may include at least one of a device identifier associated with the wireless communication device 900, a position of the wireless communication device 900, a speed at which the wireless communication device 900 is moving, or a direction in which the wireless communication device 900 is moving. In another aspect, the feedback report may indicate at least one of a time at which the feedback report was transmitted or a modulation type for each of the WLAN channels or the DSRC channels on which the wireless communication device 900 is communicating. In another configuration, the processing system 910 and/or the receiver 905 may be configured to receive additional device information associated with at least one other wireless device, and the feedback report may include the additional device information associated with the at least one other wireless device. In another configuration, the radar component 926 may be configured to determine whether any 5 GHz channels include radar signals and provide an indication of radar signals 934 to the device feedback component 924. In another configuration, the processing system 910 and/or the activity measurement component 928 may be configured to determine an amount of activity on wireless channels (e.g., an indication of non-radar signals 936) by determining a first amount of activity on one or more WLAN channels and by determining a second amount of activity on one or more DSRC channels. In this configuration, the feedback report may indicate the amount of activity on the wireless channels. In another configuration, the processing system 910 and/or the transmitter 915 may be configured to transmit a request to communicate on a WLAN channel or a DSRC channel. The request may include at least one of a position of the wireless communication device 900, a speed at which the wireless communication device 900 is moving, or a direction in which the wireless communication device 900 is moving. The processing system 910 and/or the receiver 905 may be configured to receive channel status information (e.g., channel status information 930) based on the transmitted request, and the channel status information may indicate at least one of a recommended WLAN channel or a recommended DSRC channel. In this configuration, the device feedback component 924 may be configured to select a channel based on the received channel status information. In another configuration, the processing system 910 and/or the transmitter 915 may be configured to transmit a message indicating the selected channel on which the wireless communication device 900 is communicating. In another configuration, the processing system 910 and/or the device feedback component 924 may be configured to update the device information associated with the wireless communication device 900. The device information may include at least one of the position of the wireless communication device 900, the speed at which the wireless communication device 900 is moving, or the direction in which the wireless communication device 900 is moving. The processing system 910 and/or the transmitter 915 may be configured to transmit the updated device information. The processing system 910 and/or the receiver 905 may be configured to receive a channel move request based on the updated device information.

The receiver 905, the processing system 910, the device feedback component 924, and/or the transmitter 915 may be configured to perform one or more functions discussed above with respect to blocks 705, 710, 715, 720, and 725 of FIG. 7 and to blocks 805, 810, 815, 820, 825, 830, and 835 of FIG. 8. The receiver 905 may correspond to the receiver 612. The processing system 910 may correspond to the processor 604. The transmitter 915 may correspond to the transmitter 610. The device feedback component 924 may correspond to the device feedback component 126, and/or the device feedback component 624.

In one configuration, the wireless communication device 900 may include means for determining device information associated with the wireless device. The device information may identify at least one channel on which the wireless device is communicating, and the at least one channel may be a WLAN channel and/or a DSRC channel. The wireless communication device 900 includes means for transmitting a feedback report that includes the device information over a WAN connection. In an aspect, the device information may include at least one of a device identifier associated with the wireless communication device 900, a position of the wireless communication device 900, a speed at which the wireless communication device 900 is moving, and/or a direction in which the wireless communication device 900 is moving. In another aspect, the feedback report may indicate at least one of a time at which the feedback report was transmitted or a modulation type for each of the WLAN channels or the DSRC channels on which the wireless communication device 900 is communicating. In another configuration, the wireless communication device 900 may include means for receiving additional device information associated with at least one other wireless device. The feedback report may include the additional device information associated with the at least one other wireless device. In another configuration, the wireless communication device 900 may include means for determining an amount of activity on wireless channel. The means for determining the amount of activity may be configured to determine a first amount of activity on one or more WLAN channels and to determine a second amount of activity on one or more DSRC channels. In this configuration, the feedback report may indicate the amount of activity on the wireless channels. In another configuration, the wireless communication device 900 may include means for transmitting a request to communicate on a WLAN channel or a DSRC channel. In this configuration, the request may include at least one of a position of the wireless communication device 900, a speed at which the wireless communication device 900 is moving, or a direction in which the wireless communication device 900 is moving. The wireless communication device 900 may include means for receiving channel status information based on the transmitted request. The channel status information may indicate at least one of a recommended WLAN channel and/or a recommended DSRC channel. The wireless communication device 900 may include means for selecting a channel based on the received channel status information. In another configuration, the wireless communication device 900 may include means for transmitting a message indicating the selected channel on which the wireless device is communicating. In another configuration, the wireless communication device 900 may include means for updating device information associated with the wireless device. In this configuration, the device information may include at least one of the position of the wireless communication device 900, the speed at which the wireless communication device 900 is moving, or the direction in which the wireless communication device 900 is moving. The wireless communication device 900 may include means for transmitting the updated device information. The wireless communication device 900 may include means for receiving a channel move request based on the updated device information.

For example, means for determining device information may include the processing system 910 and/or the device feedback component 924. Means for transmitting may include the processing system 910 and/or the transmitter 915. Means for receiving may include the processing system 910 and/or the receiver 905. Means for determining an amount of activity on wireless channels may include the processing system 910 and/or the activity measurement component 928. Means for selecting may include the processing system 910 and/or the device feedback component 924. Means for updating may include the processing system 910 and/or the device feedback component 924.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

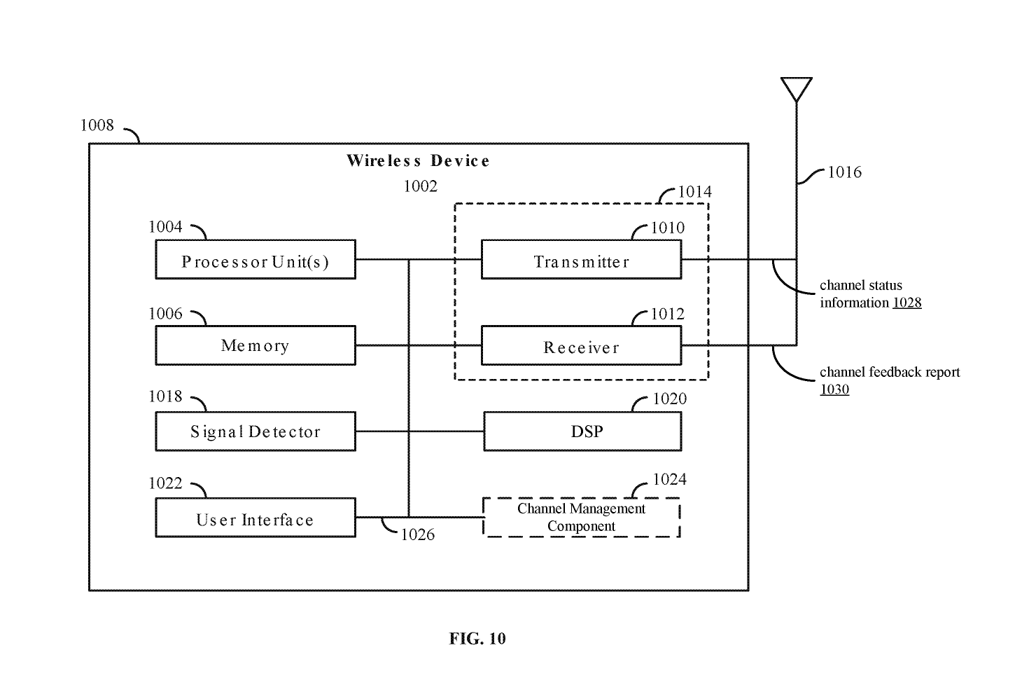

FIG. 10 shows an example functional block diagram of a wireless device 1002 that may perform channel management within the wireless communication system 100 of FIG. 1. The wireless device 1002 is an example of a device that may be configured to implement the various methods described herein. For example, the wireless device 1002 may a core network 120 (or the core network 410) or a device/entity within the core network 120 (e.g., the base station 412).

The wireless device 1002 may include a processor 1004 which controls operation of the wireless device 1002. The processor 1004 may also be referred to as a CPU. Memory 1006, which may include both ROM and RAM, may provide instructions and data to the processor 1004. A portion of the memory 1006 may also include NVRAM. The processor 1004 typically performs logical and arithmetic operations based on program instructions stored within the memory 1006. The instructions in the memory 1006 may be executable (by the processor 1004, for example) to implement the methods described herein.

The processor 1004 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 1002 may also include a housing 1008, and the wireless device 1002 may include a transmitter 1010 and/or a receiver 1012 to allow transmission and reception of data between the wireless device 1002 and a remote device. The transmitter 1010 and the receiver 1012 may be combined into a transceiver 1014. An antenna 1016 may be attached to the housing 1008 and electrically coupled to the transceiver 1014. The wireless device 1002 may also include multiple transmitters, multiple receivers, multiple transceivers, and/or multiple antennas.

The wireless device 1002 may also include a signal detector 1018 that may be used to detect and quantify the level of signals received by the transceiver 1014 or the receiver 1012. The signal detector 1018 may detect such signals as total energy, energy per subcarrier per symbol, power spectral density, and other signals. The wireless device 1002 may also include a DSP 1020 for use in processing signals. The DSP 1020 may be configured to generate a packet for transmission. In some aspects, the packet may comprise a PPDU.

The wireless device 1002 may further comprise a user interface 1022 in some aspects. The user interface 1022 may comprise a keypad, a microphone, a speaker, and/or a display. The user interface 1022 may include any element or component that conveys information to a user of the wireless device 1002 and/or receives input from the user.

When the wireless device 1002 is implemented as a core network, the wireless device 1002 may also comprise a channel management component 1024. The channel management component 1024 may be configured to receive a feedback report from a first wireless device. The channel feedback report may indicate a channel on which the first wireless device is communicating, a position of the first wireless device, a speed at which the first wireless device is moving, and a direction in which the first wireless device is moving. The channel management component 1024 may be configured to receive, from a second wireless device, a request to communicate on a WLAN channel and/or a DSRC channel. The channel management component 1024 may be configured to allocate a set of channels to the second wireless device based on the received feedback report and the received request. The channel management component 1024 may be configured to transmit channel status information to the second wireless device that indicates the determined set of channels. In an aspect, the request may include at least one of a position of the second wireless device, a speed at which the second wireless device is moving, and/or a direction in which the second wireless device is moving. In another configuration, the channel management component 1024 may be configured to allocate the set of channels by determining a distance between the first wireless device and the second wireless device based on the position of the first wireless device and the position of the second wireless device and by identifying the set of channels based on the distance between the first wireless device and the second wireless device. In another configuration, the channel management component 1024 may be configured to allocate the set of channels by determining a first expected position of the first wireless device during a communication interval associated with one or more available channels based on the position, the speed, and the direction of the first wireless device, by determining a second expected position of the second wireless device during the communication interval based on the position, the speed, and the direction of the second wireless device, by determining an expected distance between the first wireless device and the second wireless device during the communication interval based on the first expected position and the second expected position, and by identifying the set of channels based on the expected distance between the first wireless device and the second wireless device. The set of channels may be a subset of the one or more available channels. In another configuration, the channel management component 1024 may be configured to receive additional feedback reports from additional wireless devices. The set of channels may be allocated based on the received additional feedback reports. In another configuration, the request may indicate device capabilities associated with the second wireless device, and the set of channels may be allocated based on the device capabilities indicated in the request. In another configuration, the channel management component 1024 may be configured to receive updated device information from the second wireless device, to allocate a second set of channels to the second wireless device based on the updated device information, and to transmit a channel move request to the second wireless device based on the allocated second set of channels.

The various components of the wireless device 1002 may be coupled together by a bus system 1026. The bus system 1026 may include a data bus, for example, as well as a power bus, a control signal bus, and a status signal bus in addition to the data bus. Components of the wireless device 1002 may be coupled together or accept or provide inputs to each other using some other mechanism.

Although a number of separate components are illustrated in FIG. 10, one or more of the components may be combined or commonly implemented. For example, the processor 1004 may be used to implement not only the functionality described above with respect to the processor 1004, but also to implement the functionality described above with respect to the signal detector 1018, the DSP 1020, the user interface 1022, and/or the channel management component 1024. Further, each of the components illustrated in FIG. 10 may be implemented using a plurality of separate elements.

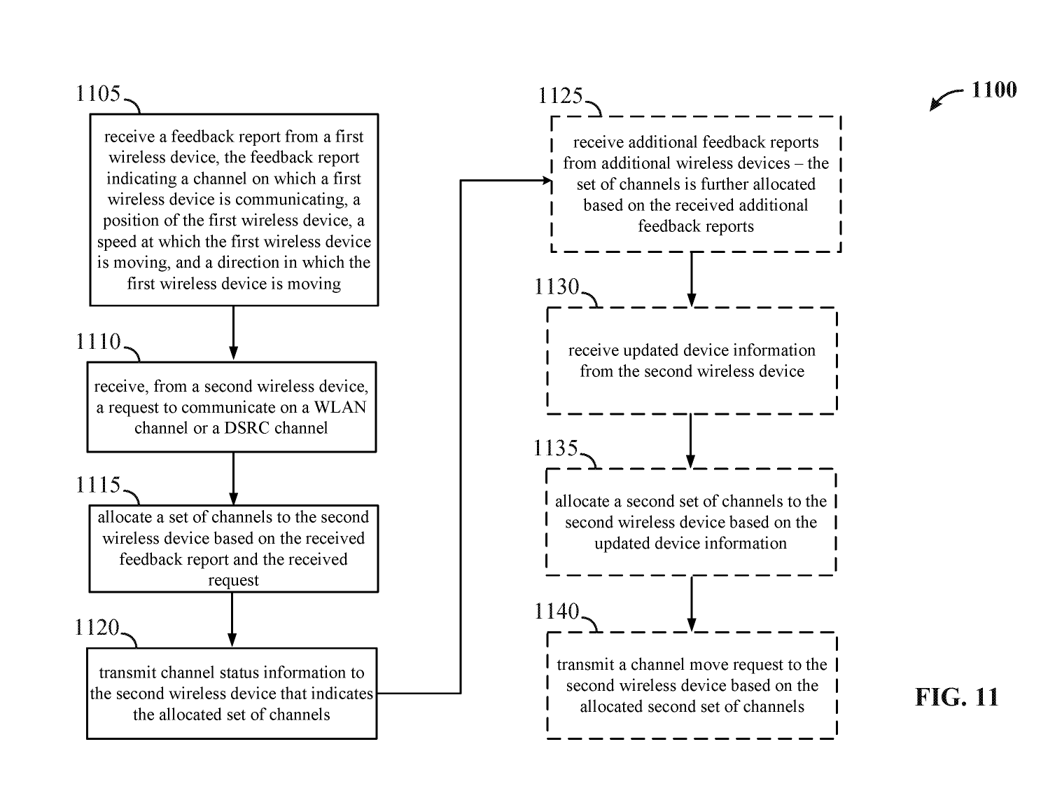

FIG. 11 is a flowchart of an example method 1100 for performing channel management for WLAN and/or DSRC channels. The method 1100 may be performed using an apparatus (e.g., the core network 120, the core network 410, the base station 412, or the wireless device 1002, for example). Although the method 1100 is described below with respect to the elements of wireless device 1002 of FIG. 10, other components may be used to implement one or more of the steps described herein.

At block 1105, the apparatus may receive a feedback report from a first wireless device. The feedback report may indicate a channel on which a first wireless device is communicating, a position of the first wireless device, a speed at which the first wireless device is moving, and a direction in which the first wireless device is moving. For example, referring to FIG. 4, the core network 410 (corresponding to the apparatus) may receive a feedback report from the wireless device 406 (corresponding to the first wireless device). The feedback report may indicate the position of the wireless device 406, the speed at which the wireless device 406 is moving, and a direction in which the wireless device 406 is moving. In this example, the core network 410 may also receive feedback reports from the wireless devices 402, 408.

At block 1110, the apparatus may receive, from a second wireless device, a request to communicate on a WLAN channel and/or a DSRC channel. In an aspect, the request may include at least one of a position of the second wireless device, a speed at which the second wireless device is moving, or a direction in which the second wireless device is moving. For example, referring to FIG. 4, the core network 410 may receive from the wireless device 404 (corresponding to the second wireless device) a request to communicate on WLAN and DSRC channel. The request may include a position, speed, and direction of travel associated with the wireless device 404.

At block 1115, the apparatus may allocate a set of channels to the second wireless device based on the received feedback report and the received request. For example, referring to FIG. 4, the core network 410 may allocate a set of channels to the wireless device 404 based on the received feedback report from the wireless device 406 (and/or feedback reports from wireless devices 402, 408) and on the received request from the wireless device 404. In an aspect, the set of channels may be allocated based, at least in part, on an admissions policy.

At 1120, the apparatus may transmit channel status information to the second wireless device that indicates the allocated set of channels. For example, referring to FIG. 4, the core network 410 may transmit channel status information to the wireless device 404 that indicates the allocated set of WLAN and/or DSRC channels.

At 1125, the apparatus may receive additional feedback reports from additional wireless devices. The set of channels may be further allocated based on the received additional feedback reports. For example, referring to FIG. 4, the core network 410 may receive feedback reports from wireless devices 402, 406, 408. The core network 410 may receive feedback reports from any number of wireless devices and allocate channels based on the received feedback.

At 1130, the apparatus may receive updated device information from the second wireless device. For example, referring to FIG. 4, the core network 410 may receive updated device information from the wireless device 404 based when on when the wireless device 404 changes position, speed, or direction.

At 1135, the apparatus may allocate a second set of channels to the second wireless device based on the updated device information. For example, the core network 410 may allocate a second set of channels to the wireless device 404 based on the updated device information. In this example, the core network 410 may allocate the second set of channels based on updated position, speed, or direction information associated with the wireless device 404. The allocated channels may change based on channel reuse zone 414 being moved to the channel reuse zone 414″.

At 1140, the apparatus may transmit a channel move request to the second wireless device based on the allocated second set of channels. For example, referring to FIG. 4, having allocated the second set of channels, the core network 410 may transmit a channel move request to the wireless device 404. The channel move request may indicate the allocated second set of channels.

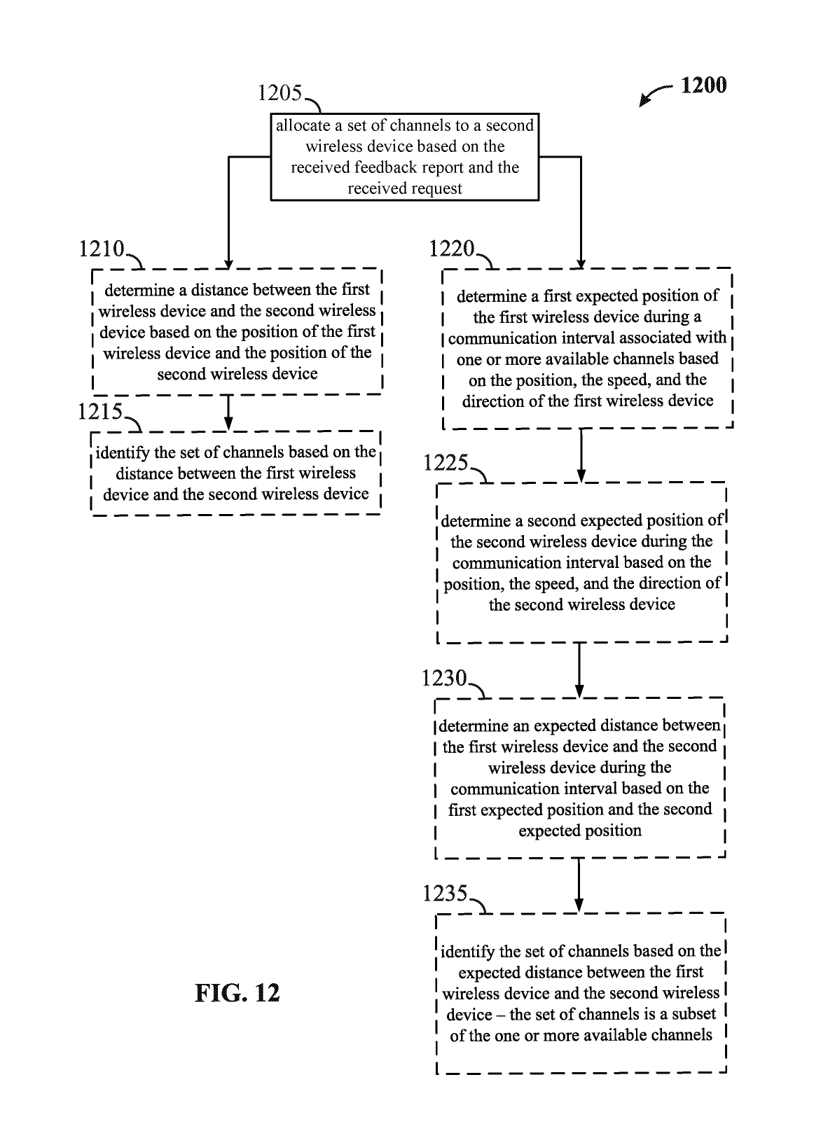

FIG. 12 is a flowchart of an example method 1200 for allocating WLAN and/or DSRC channels. The method 1200 may be performed using an apparatus (e.g., the core network 120, the core network 410, the base station 412, or the wireless device 1002, for example). Although the method 1200 is described below with respect to the elements of wireless device 1002 of FIG. 10, other components may be used to implement one or more of the steps described herein.

At block 1205, the apparatus may allocate a set of channels to a second wireless device based on a received feedback report and on a received request. For example, referring to FIG. 4, the core network 410 may allocate a set of channels to the wireless device 404 based on a feedback report received from the wireless device 406 and a request to communication on WLAN and/or DSRC channels from the wireless device 404.

In one configuration, the apparatus may allocate the set of channels by determining a distance between the first wireless device and the second wireless device based on the position of the first wireless device and the position of the second wireless device (at block 1210) and by identifying the set of channels based on the distance between the first wireless device and the second wireless device (at block 1215). For example, the core network 410 may allocate the set of channels by determining a distance between the wireless device 406 and the wireless device 404 based on the position of the wireless device 406 and the position of the wireless device 404. The core network 410 may identifying the set of channels based on the distance between the wireless device 406 and the wireless device 404. In this configuration, the core network 410 may identify channels for the wireless device 404 that are not being used by other wireless devices (e.g., the wireless device 406) in the channel reuse zone 414. However, if all channels are being used in the channel reuse zone 414, then the core network 410 may adjust the channel reuse zone 414 by having the reduced size channel reuse zone 414′ with a reduced radius (or size) such that the wireless device 406 is outside of the reduced size channel reuse zone 414′ with reduced radius (or size). In this aspect, the wireless devices 404, 406 may use the same channel.

In another configuration, the apparatus may allocate the set of channels by determining a first expected position of the first wireless device during a communication interval associated with one or more available channels based on the position, the speed, and the direction of the first wireless device, by determining a second expected position of the second wireless device during the communication interval based on the position, the speed, and the direction of the second wireless device, by determining an expected distance between the first wireless device and the second wireless device during the communication interval based on the first expected position and the second expected position, and by identifying the set of channels based on the expected distance between the first wireless device and the second wireless device. The set of channels may be a subset of the one or more available channels. For example, the core network 410 may allocate the set of channels by determining a first expected position of the wireless device 406 during a communication interval associated with one or more available channels based on the position, the speed, and the direction of the wireless device 406, by determining a second expected position of the wireless device 404 during the communication interval based on the position, the speed, and the direction of the wireless device 404, by determining an expected distance between the wireless device 406 and the wireless device 404 during the communication interval based on the first expected position and the second expected position, and by identifying the set of channels based on the expected distance between the wireless device 406 and the wireless device 404. If the wireless devices 404, 406 are expected to be in the same channel reuse zone during communications, then different channel may be allocated; otherwise, the same channel may be allocated to both devices. In an aspect, the allocated set of channels may be a subset of the one or more available channels.

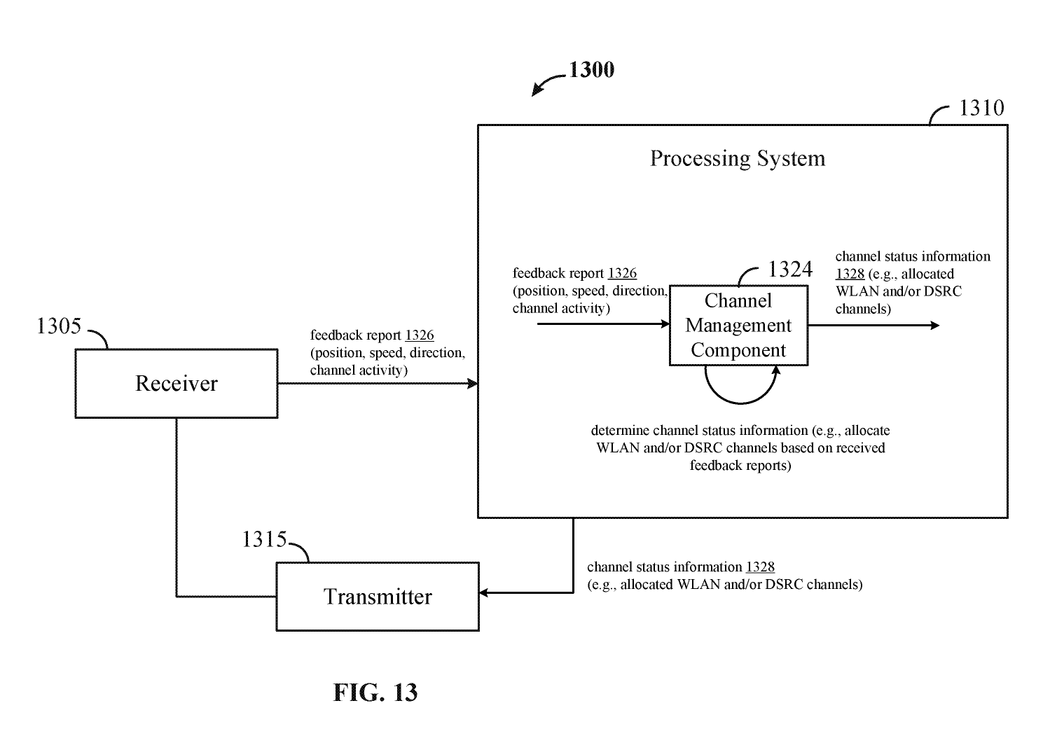

FIG. 13 is a functional block diagram of an example wireless communication device 1300 that performs channel management. The wireless communication device 1300 may include a receiver 1305, a processing system 1310, and a transmitter 1315. The processing system 1310 may include a channel management component 1324. In one configuration, the processing system 1310, the channel management component 1324, and/or the receiver 1305 may be configured to receive a feedback report (e.g., a feedback report 1326) from a first wireless device. The feedback report may indicate a channel on which the first wireless device is communicating, a position of the first wireless device, a speed at which the first wireless device is moving, and a direction in which the first wireless device is moving. The processing system 1310, the channel management component 1324, and/or the receiver 1305 may be configured to receive, from a second wireless device, a request to communicate on a WLAN channel or a DSRC channel. The processing system 1310 and/or the channel management component 1324 may be configured to allocate a set of channels to the second wireless device based on the received feedback report and the received request. The processing system 1310, the channel management component 1324, and/or the transmitter 1315 may be configured to transmit channel status information (e.g., channel status information 1328) to the second wireless device that indicates the allocated set of channels. In an aspect, the request may include at least one of a position of the second wireless device, a speed at which the second wireless device is moving, or a direction in which the second wireless device is moving. In another configuration, the processing system 1310 and/or the channel management component 1324 may be configured to allocate the set of channels by determining a distance between the first wireless device and the second wireless device based on the position of the first wireless device and the position of the second wireless device and by identifying the set of channels based on the distance between the first wireless device and the second wireless device. In another configuration, the processing system 1310 and/or the channel management component 1324 may be configured to allocate the set of channels by determining a first expected position of the first wireless device during a communication interval associated with one or more available channels based on the position, the speed, and the direction of the first wireless device, by determining a second expected position of the second wireless device during the communication interval based on the position, the speed, and the direction of the second wireless device, by determining an expected distance between the first wireless device and the second wireless device during the communication interval based on the first expected position and the second expected position, and by identifying the set of channels based on the expected distance between the first wireless device and the second wireless device. In this configuration, the set of channels may be a subset of the one or more available channels. In another configuration, the processing system 1310, the channel management component 1324, and/or the receiver 1305 may be configured to receive additional feedback reports from additional wireless devices. In this configuration, the set of channels may be allocated based on the received additional feedback reports. In an aspect, the request may indicate device capabilities associated with the second wireless device, and the set of channels may be allocated based on the device capabilities indicated in the request. In another configuration, the processing system 1310, the channel management component 1324, and/or the receiver 1305 may receive updated device information from the second wireless device. The channel management component 1324 and/or the processing system 1310 may allocate a second set of channels to the second wireless device based on the updated device information. The channel management component 1324, the processing system 1310, and/or the transmitter 1315 may transmit a channel move request to the second wireless device based on the allocated second set of channels.

The receiver 1305, the processing system 1310, the channel management component 1324, and/or the transmitter 1315 may be configured to perform one or more functions discussed above with respect to blocks 1105, 1110, 1115, 1120, 1125, 1130, 1135, and 1140 of FIG. 11 and to blocks 1205, 1210, 1215, 1220, 1225, 1230, and 1235 of FIG. 12. The receiver 1305 may correspond to the receiver 1012. The processing system 1310 may correspond to the processor 1004. The transmitter 1315 may correspond to the transmitter 1010. The channel management component 1324 may correspond to the channel management component 124, and/or the channel management component 1024.

In one configuration, the wireless communication device 1300 may include means for receiving a feedback report from a first wireless device, the feedback report indicating a channel on which the first wireless device is communicating, a position of the first wireless device, a speed at which the first wireless device is moving, and a direction in which the first wireless device is moving. The wireless communication device 1300 may include means for receiving, from a second wireless device, a request to communicate on a WLAN channel or a DSRC channel. The wireless communication device 1300 may include means for allocating a set of channels to the second wireless device based on the received feedback report and the received request. The wireless communication device 1300 may include means for transmitting channel status information to the second wireless device that indicates the allocated set of channels. In an aspect, the request may include at least one of a position of the second wireless device, a speed at which the second wireless device is moving, or a direction in which the second wireless device is moving. In another configuration, the means for allocating the set of channels may be configured to determine a distance between the first wireless device and the second wireless device based on the position of the first wireless device and the position of the second wireless device and to identify the set of channels based on the distance between the first wireless device and the second wireless device. In another configuration, the means for allocating the set of channels may be configured to determine a first expected position of the first wireless device during a communication interval associated with one or more available channels based on the position, the speed, and the direction of the first wireless device, to determine a second expected position of the second wireless device during the communication interval based on the position, the speed, and the direction of the second wireless device, to determine an expected distance between the first wireless device and the second wireless device during the communication interval based on the first expected position and the second expected position, and to identify the set of channels based on the expected distance between the first wireless device and the second wireless device. In this configuration, the set of channels may be a subset of the one or more available channels. In another configuration, the wireless communication device 1300 may include means for receiving additional feedback reports from additional wireless devices, and the set of channels may be further allocated based on the received additional feedback reports. In another aspect, the request may indicate device capabilities associated with the second wireless device, and the set of channels may be allocated based on the device capabilities indicated in the request. In another configuration, the wireless communication device 1300 may include means for receiving updated device information from the second wireless device, means for allocating a second set of channels to the second wireless device based on the updated device information, and means for transmitting a channel move request to the second wireless device based on the allocated second set of channels.

For example, means for receiving may include the processing system 1310, the channel management component 1324, and/or the receiver 1305. Means for allocating may include the processing system 1310 and/or the channel management component 1324. Means for transmitting may include the processing system 1310, the channel management component 1324, and/or the transmitter 1315.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and blu-ray disc where disks usually reproduce data magnetically, while discs reproduce data optically with lasers. Thus, computer readable medium comprises non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication by a wireless device, comprising:
determining device information associated with the wireless device, wherein the device information identifies at least one channel on which the wireless device is communicating, and the at least one channel is a wireless local area network (WLAN) channel or a dedicated short range communications (DSRC) channel; and
transmitting a feedback report that includes the device information over a wide area network (WAN) connection.

2. The method of claim 1, wherein the device information further comprises at least one of a device identifier associated with the wireless device, a position of the wireless device, a speed at which the wireless device is moving, or a direction in which the wireless device is moving.

3. The method of claim 1, wherein the feedback report indicates at least one of a time at which the feedback report was transmitted or a modulation type for each of the WLAN channel or the DSRC channel on which the wireless device is communicating.

4. The method of claim 1, further comprising receiving additional device information associated with at least one other wireless device, wherein the feedback report further comprises the additional device information associated with the at least one other wireless device.

5. The method of claim 1, further comprising determining an amount of activity on wireless channels, wherein the determining comprises:
determining a first amount of activity on one or more WLAN channels; and
determining a second amount of activity on one or more DSRC channels,
wherein the feedback report indicates the amount of activity on the wireless channels.

6. The method of claim 1, further comprising:
transmitting a request to communicate on a WLAN channel or a DSRC channel, wherein the request includes at least one of a position of the wireless device, a speed at which the wireless device is moving, or a direction in which the wireless device is moving;
receiving channel status information based on the transmitted request, wherein the channel status information indicates at least one of an allocated WLAN channel or an allocated DSRC channel; and
selecting a channel based on the received channel status information.

7. The method of claim 6, further comprising transmitting a message indicating the selected channel on which the wireless device is communicating.

8. The method of claim 1, further comprising:
updating the device information associated with the wireless device, wherein the updated device information includes at least one of the position of the wireless device, the speed at which the wireless device is moving, or the direction in which the wireless device is moving;
transmitting the updated device information; and
receiving a channel move request based on the updated device information.

9. A method of wireless communication, comprising:
receiving a feedback report from a first wireless device, the feedback report indicating a channel on which the first wireless device is communicating, a position of the first wireless device, a speed at which the first wireless device is moving, and a direction in which the first wireless device is moving;
receiving, from a second wireless device, a request to communicate on a wireless local area network (WLAN) channel or a dedicated short range communications (DSRC) channel;
allocating a set of channels to the second wireless device based on the received feedback report and the received request; and
transmitting channel status information to the second wireless device that indicates the allocated set of channels.

10. The method of claim 9, wherein the request includes at least one of a position of the second wireless device, a speed at which the second wireless device is moving, or a direction in which the second wireless device is moving.

11. The method of claim 10, wherein the allocating the set of channels comprises:
determining a distance between the first wireless device and the second wireless device based on the position of the first wireless device and the position of the second wireless device; and
identifying the set of channels based on the distance between the first wireless device and the second wireless device.

12. The method of claim 10, wherein the allocating the set of channels further comprises:
determining a first expected position of the first wireless device during a communication interval associated with one or more available channels based on the position, the speed, and the direction of the first wireless device;
determining a second expected position of the second wireless device during the communication interval based on the position, the speed, and the direction of the second wireless device;
determining an expected distance between the first wireless device and the second wireless device during the communication interval based on the first expected position and the second expected position; and
identifying the set of channels based on the expected distance between the first wireless device and the second wireless device, wherein the set of channels is a subset of the one or more available channels.

13. The method of claim 9, further comprising receiving additional feedback reports from additional wireless devices, wherein the set of channels is further allocated based on the received additional feedback reports.

14. The method of claim 9, wherein the request indicates device capabilities associated with the second wireless device, and wherein the set of channels is allocated based on the device capabilities indicated in the request.

15. The method of claim 9, further comprising:
receiving updated device information from the second wireless device;
allocating a second set of channels to the second wireless device based on the updated device information; and
transmitting a channel move request to the second wireless device based on the allocated second set of channels.

16. An apparatus for wireless communication, the apparatus being a wireless device, comprising:
a memory; and
at least one processor coupled to the memory and configured to:
determine device information associated with the wireless device, wherein the device information identifies at least one channel on which the wireless device is communicating, and the at least one channel is a wireless local area network (WLAN) channel or a dedicated short range communications (DSRC) channel; and
transmit a feedback report that includes the device information over a wide area network (WAN) connection.

17. The apparatus of claim 16, wherein the device information further comprises at least one of a device identifier associated with the wireless device, a position of the wireless device, a speed at which the wireless device is moving, or a direction in which the wireless device is moving.

18. The apparatus of claim 16, wherein the feedback report indicates at least one of a time at which the feedback report was transmitted or a modulation type for each of the WLAN channel or the DSRC channel on which the wireless device is communicating.

19. The apparatus of claim 16, wherein the at least one processor is further configured to receive additional device information associated with at least one other wireless device, wherein the feedback report further comprises the additional device information associated with the at least one other wireless device.

20. The apparatus of claim 16, wherein the at least one processor is further configured to determine an amount of activity on wireless channels, and the at least one processor is configured to determine the amount of activity by:
determining a first amount of activity on one or more WLAN channels; and
determining a second amount of activity on one or more DSRC channels,
wherein the feedback report indicates the amount of activity on the wireless channels.

21. The apparatus of claim 16, wherein the at least one processor is further configured to:
transmit a request to communicate on a WLAN channel or a DSRC channel, wherein the request includes at least one of a position of the wireless device, a speed at which the wireless device is moving, or a direction in which the wireless device is moving;
receive channel status information based on the transmitted request, wherein the channel status information indicates at least one of an allocated WLAN channel or an allocated DSRC channel; and
select a channel based on the received channel status information.

22. The apparatus of claim 21, wherein the at least one processor is further configured to transmit a message indicating the selected channel on which the wireless device is communicating.

23. The apparatus of claim 16, wherein the at least one processor is further configured to:
update the device information associated with the wireless device, wherein the updated device information includes at least one of the position of the wireless device, the speed at which the wireless device is moving, or the direction in which the wireless device is moving;
transmit the updated device information; and
receive a channel move request based on the updated device information.

24. An apparatus for wireless communication, comprising:
a memory; and
at least one processor coupled to the memory and configured to:
receive a feedback report from a first wireless device, the feedback report indicating a channel on which the first wireless device is communicating, a position of the first wireless device, a speed at which the first wireless device is moving, and a direction in which the first wireless device is moving;
receive, from a second wireless device, a request to communicate on a wireless local area network (WLAN) channel or a dedicated short range communications (DSRC) channel;
allocate a set of channels to the second wireless device based on the received feedback report and the received request; and
transmit channel status information to the second wireless device that indicates the allocated set of channels.

25. The apparatus of claim 24, wherein the request includes at least one of a position of the second wireless device, a speed at which the second wireless device is moving, or a direction in which the second wireless device is moving.

26. The apparatus of claim 25, wherein the at least one processor is configured to allocate the set of channels by:
determining a distance between the first wireless device and the second wireless device based on the position of the first wireless device and the position of the second wireless device; and
identifying the set of channels based on the distance between the first wireless device and the second wireless device.

27. The apparatus of claim 25, wherein the at least one processor is configured to allocate the set of channels by:
determining a first expected position of the first wireless device during a communication interval associated with one or more available channels based on the position, the speed, and the direction of the first wireless device;
determining a second expected position of the second wireless device during the communication interval based on the position, the speed, and the direction of the second wireless device;
determining an expected distance between the first wireless device and the second wireless device during the communication interval based on the first expected position and the second expected position; and
identifying the set of channels based on the expected distance between the first wireless device and the second wireless device, wherein the set of channels is a subset of the one or more available channels.

28. The apparatus of claim 24, wherein the at least one processor is further configured to receive additional feedback reports from additional wireless devices, wherein the set of channels is further allocated based on the received additional feedback reports.

29. The apparatus of claim 24, wherein the request indicates device capabilities associated with the second wireless device, and wherein the set of channels is allocated based on the device capabilities indicated in the request.

30. The apparatus of claim 24, wherein the at least one processor is further configured to:
receive updated device information from the second wireless device;
allocate a second set of channels to the second wireless device based on the updated device information; and
transmit a channel move request to the second wireless device based on the allocated second set of channels.
